(19) United States
(12) Patent Application Publication
(10) Pub. No.: US 2024/0208827 A1
(43) Pub. Date: Jun. 27, 2024

(54) GROUP14 COMPOSITE

(71) Applicant: Group14 Technologies, Inc., Woodinville, WA (US)

(72) Inventor: Henry R. COSTANTINO, Woodinville, WA (US)

(21) Appl. No.: 18/576,636

(22) PCT Filed: Jul. 5, 2022
(86) PCT No.: PCT/US2022/036127

§ 371 Date: Jan. 4, 2024

Related U.S. Application Data
(60) Provisional application No. 63/218,786, filed on Jul. 6, 2021.

(51) Int. Cl. C01B 32/336; C01B 32/354; H01M 4/02; H01M 4/133; H01M 4/134; H01M 4/36; H01M 10/052

(52) U.S. Cl. CPC C01B 32/336; C01B 32/382; H01M 4/133; H01M 4/134; H01M 4/362; H01M 2004/021; H01M 10/052

(57) ABSTRACT

Particulate composite materials and devices comprising the same are provided.

### CROSS-REFERENCE TO RELATED APPLICATION

The present application is a U.S. national stage application of International Application No. PCT/US2022/036127, filed Jul. 5, 2022, which claims the benefit of the filing date, under 35 U.S.C. § 119(e), of U.S. Provisional Application No. 63/218,786, filed Jul. 6, 2021, the disclosure of which, along with all documents cited therein, is incorporated herein by reference in its entirety.

### BACKGROUND

### Technical Field

Embodiments of the present invention generally relate to spherical composite particles comprising Group14 elements and devices comprising the same. These materials are produced via process comprising hydrothermal carbonization of a polyol facilitated by a preferential exclusion agent and subsequent chemical vapor infiltration (CVI).

Embodiments of the present invention generally relate to methods of production of silicon-carbon composite materials, and their compositions of matter. Said silicon-carbon composites are produced via a processing sequence of hydrothermal processing of carbon precursor materials, pyrolysis, and activation to produce a highly microporous carbon particles, and subsequent chemical vapor infiltration to produce silicon within the pores of the microporous carbon particles to yield the final silicon-carbon composite particles. Suitable carbon precursors include, but are not limited to, sugars and other polyols, and combinations thereof.

Suitable porous scaffolds include, but are not limited to, porous carbon scaffolds, for example carbon having a pore volume comprising micropores (less than 2 nm), mesopores (2 to 50 nm), and/or macropores (greater than 50 nm). Chemical vapor infiltration (CVI) of silicon into the pores of porous scaffold materials is accomplished by exposing said porous scaffold to silicon-containing gas (e.g., silane) at elevated temperatures.

### Description of the Related Art

Chemical vapor infiltration CVI is a process wherein a gaseous substrate reacts within a porous scaffold material. This approach can be employed to produce composite materials, for instance silicon-carbon composites, wherein a silicon-containing gas decomposes at elevated temperature within a porous carbon scaffold. While this approach can be employed to manufacture a variety of composite materials, there is particular interest in silicon-carbon (Si—C) composite materials. Such Si—C composite materials have utility, for example as energy storage materials, for example as an anode material within a lithium ion battery (LIB). LIBs have potential to replace devices currently used in any number of applications. For example, current lead acid automobile batteries are not adequate for next generation all-electric and hybrid electric vehicles due to irreversible, stable sulfate formations during discharge. Lithium ion batteries are a viable alternative to the lead-based systems currently used due to their capacity, and other considerations.

To this end, there is continued strong interest in developing new LIB anode materials, particularly silicon, which has 10-fold higher gravimetric capacity than conventional graphite. However, silicon exhibits large volume change during cycling, in turn leading to electrode deterioration and solid-electrolyte interphase (SEI) instability. The most common amelioration approach is to reduce silicon particle size, for instance Dv50<150 nm, for instance Dv50<100 nm, for instance Dv50<50 nm, for instance Dv50<20 nm, for instance Dv50<10 nm, for instance Dv50<5 nm, for instance Dv50<2 nm, either as discrete particles or within a matrix. Thus far, techniques for creating nano-scale silicon involve high-temperature reduction of silicon oxide, extensive particle diminution, multi-step toxic etching, and/or other cost prohibitive processes. Likewise, common matrix approaches involve expensive materials such as graphene or nano-graphite, and/or require complex processing and coating.

It is known from scientific literature that non-graphitizable (hard) carbon is beneficial as a LIB anode material (Liu Y, Xue, J S, Zheng T, Dahn, J R. Carbon 1996, 34:193-200; Wu, Y P, Fang, S B, Jiang, Y Y. 1998, 75:201-206; Buiel E, Dahn J R. Electrochim Acta 1999 45:121-130). The basis for this improved performance stems from the disordered nature of the graphene layers that allows Li-ions to intercalate on either side of the graphene plane allowing for theoretically double the stoichiometric content of Li ions versus crystalline graphite. Furthermore, the disordered structure improves the rate capability of the material by allowing Li ions to intercalate isotropically as opposed to graphite where lithiation can only proceed in parallel to the stacked graphene planes. Despite these desirable electrochemical properties, amorphous carbons have not seen wide-spread deployment in commercial Li-ion batteries, owing primarily to low FCE and low bulk density (<1 g/cc). Instead, amorphous carbon has been used more commonly as a low-mass additive and coating for other active material components of the battery to improve conductivity and reduce surface side reactions.

In recent years, amorphous carbon as a LIB battery material has received considerable attention as a coating for silicon anode materials. Such a silicon-carbon core-shell structure has the potential for not only improving conductivity, but also buffering the expansion of silicon as it lithiates, thus stabilizing its cycle stability and minimizing problems associated with particle pulverization, isolation, and SEI integrity (Jung, Y, Lee K, Oh, S. Electrochim Acta 2007 52:7061-7067; Zuo P, Yin G, Ma Y. Electrochim Acta 2007 52:4878-4883; Ng S H, Wang J, Wexler D, Chew S Y, Liu H K. J Phys Chem C 2007 111:11131-11138). Problems associated with this strategy include the lack of a suitable silicon starting material that is amenable to the coating process, and the inherent lack of engineered void space within the carbon-coated silicon core-shell composite particle to accommodate expansion of the silicon during lithiation. This inevitably leads to cycle stability failure due to destruction of core-shell structure and SEI layer (Beattie S D, Larcher D, Morcrette M, Simon B, Tarascon, J-M. J Electrochem Soc 2008 155:A158-A163).

An alternative to core shell structure is a structure wherein amorphous, nano-sized silicon is homogenously distributed within the porosity of a porous carbon scaffold. The porous carbon allows for desirable properties: (i) carbon porosity provides void volume to accommodate the expansion of silicon during lithiation thus reducing the net composite particle expansion at the electrode level; (ii) the disordered graphene network provides increased electrical conductivity to the silicon thus enabling faster charge/discharge rates, (iii) nano-pore structure acts as a template for the synthesis of silicon thereby dictating its size, distribution, and morphology.

To this end, the desired inverse hierarchical structure can be achieved by employing CVI wherein a silicon-containing gas can completely permeate nanoporous carbon and decompose therein to nano-sized silicon. The CVI approach confers several advantages in terms of silicon structure. One advantage is that nanoporous carbon provides nucleation sites for growing silicon while dictating maximum particle shape and size. Confining the growth of silicon within a nano-porous structure affords reduced susceptibility to cracking or pulverization and loss of contact caused by expansion. Moreover, this structure promotes nano-sized silicon to remain as amorphous phase. This property provides the opportunity for high charge/discharge rates, particularly in combination with silicon's vicinity within the conductive carbon scaffold. This system provides a high-rate-capable, solid-state lithium diffusion pathway that directly delivers lithium ions to the nano-scale silicon interface. Another benefit of the silicon provide via CVI within the carbon scaffold is the inhibition of formation of undesirable crystalline Li₁₅Si₄ phase. Yet another benefit is that the CVI process provides for void space within the particle interior.

In order to gauge relative amount of silicon impregnated into the porosity of the porous carbon, thermogravimetric analysis (TGA) may be employed. TGA can be employed to assess the fraction of silicon residing within the porosity of porous carbon relative to the total silicon present, i.e., sum of silicon within the porosity and on the particle surface. As the silicon-carbon composite is heated under air, the sample exhibits a mass increase that initiates at about 300° ° C. to 500° C. that reflects initial oxidation of silicon to SiO2, and then the sample exhibits a mass loss as the carbon is burned off, and then the sample exhibits mass increase reflecting resumed conversion of silicon into SiO2 which increases towards an asymptotic value as the temperature approaches 1100° C. as silicon oxidizes to completion. For the purposes of this analysis, it is assumed that the minimum mass recorded for the sample as it heated from 800° C. to 1100° C. represents the point at which carbon burn off is complete. Any further mass increase beyond that point corresponds to the oxidation of silicon to SiO2 and that the total mass at completion of oxidation is SiO2. Thus, the percentage of unoxidized silicon after carbon burnoff as a proportion of the total amount of silicon can be determined using the formula:

$$Z = 1.875 \times [ ( M 1100 - M ) / M 1100 ] \times 100$$

where M1100 is the mass of the sample at completion of oxidation at a temperature of 1100° C., and M is the minimum mass recorded for the sample as it is heated from 800° ° C. to 1100° C.

Without being bound by theory, the temperature at which silicon is oxidized under TGA conditions relates to the length scale of the oxide coating on the silicon due to the diffusion of oxygen atoms through the oxide layer. Thus, silicon residing within the carbon porosity will oxidize at a lower temperature than deposits of silicon on a particle surface due to the necessarily thinner coating existing on these surfaces. In this fashion, calculation of Z is used to quantitatively assess the fraction of silicon not impregnated within the porosity of the porous carbon scaffold.

### BRIEF SUMMARY

Disclosed herein are compositions and manufacturing methods related to spherical and unimodal composite materials comprising Group14 elements. As used herein, “Group14” refers to Group 14 (IVa) of the periodic table. The spherical composite particles are produced by creation of primary micron-sized, spherical, and microporous carbon particles, and subsequent creation of nano-sized amorphous silicon within the pores of the spherical porous carbon scaffold particles. To this end, the creation of silicon is accomplished by chemical vapor infiltration (CVI). The employment of spherical carbon scaffold particles provides advantages over the prior art, for example compared to employment of secondary, micron-sized porous carbon particles. Herein, “primary micron-sized” as a descriptor for porous carbon scaffold particles refers to a case where the particles are synthesized as micron-sized particles upon their creation, for example the particles upon their creation comprise a particle size distribution comprising particles in the range of 1 μm to 100 μm; notably, no particle size reduction is necessary prior to CVI processing to create the final micron-sized composite particles. Furthermore herein, “secondary micron-sized” as a descriptor for porous carbon scaffold particles refers to a case where achievement of micron sized particles (for example, achievement of particles with a particle size distribution comprising particles in the range of 1 μm to 100 μm) is achieved by particle sized reduction after synthesis of the porous carbon scaffold material.

The employment of primary micron-sized porous carbon particles to create the composite particles comprising Group 14 elements has numerous advantages as disclosed herein. One advantage is elimination of a particle size reduction step, which can be accomplished as described in the art, for example abrasion type milling processes such particle size reduction using a hammer mill, ball mill, jet mill, or other abrasion type mill. Abrasion milling to produce micronized carbon scaffold particles often exhibits broad particle size distributions, irregular and jagged morphology, and large fraction of fines that can present challenges and inconsistencies with handling, processing, and performance of particle for use in a lithium-ion battery system. The methods outlined here describe the synthesis of micron-sized spherical carbon particles that forego the need for milling. In some embodiments the micron-sized spherical carbon particles are prepared as discrete particles and are not agglomerated. Beyond foregoing the need for milling, the spherical morphology and unimodal particle size distribution for the composite material results in superior electrochemical properties due to minimization of particle surface area and, without being bound by the theory, avoidance of planar or point contacts with potential for increasing particle resistance or undesired reaction sites.

Composites comprising Group 14 elements such as silicon and carbon, are disclosed, wherein said composites have novel properties that overcome the challenges for providing amorphous nano-sized silicon entrained within porous carbon. Said silicon-carbon composites may be produced via chemical vapor infiltration to impregnate amorphous, nano-sized silicon within the pores of a porous scaffold. Suitable porous scaffolds include, but are not limited to, porous carbon scaffolds, for example carbon having a pore volume comprising micropores (less than 2 nm), mesopores (2 to 50 nm), and/or macropores (greater than 50 nm). Suitable precursors for the carbon scaffold include, but are not limited to, sugars and polyols, organic acids, phenolic compounds, cross-linkers, and amine compounds. Suitable compositing materials include, but are not limited to, silicon materials. Precursors for the silicon include, but are not limited to, silicon containing gases such as silane, high-order silanes (such as di-, tri-, and/or tetrasilane), and/or chlorosilane(s) (such as mono-, di-, tri-, and tetrachlorosilane) and mixtures thereof. CVI to produce silicon within the pores of porous scaffold materials is accomplished by exposing said porous scaffold to silicon-containing gas (e.g., silane) at elevated temperatures. The porous carbon scaffold can be a particulate porous carbon.

A key outcome in this regard is to achieve the desired form of silicon in the desired form, namely amorphous nano-sized silicon. Furthermore, another key outcome is to achieve the silicon impregnation within the pores of the porous carbon. Such materials, for example, silicon-carbon composite materials, have utility as anode materials for energy storage devices, for example lithium ion batteries.

### BRIEF DESCRIPTION OF THE DRAWINGS

FIG. 1. Relationship between Z and average Coulombic efficiency for various silicon-carbon composite materials.

FIG. 2. Differential capacity vs voltage plot for Silicon-Carbon Composite 3 from 2^{nd} cycle using a half-cell.

FIG. 3. Differential capacity vs voltage plot for Silicon-Carbon Composite 3 from 2^{nd} cycle to 5^{th} cycle using a half-cell.

FIG. 4. dQ/dV vs V plot for various silicon-carbon composite materials.

FIG. 5. Example of Calculation of φ for Silicon-Carbon Composite 3.

FIG. 6. Z vs φ plot for various silicon-carbon composite materials.

FIG. 7. SEM of Carbon Scaffold 12 comprising primary spherical pyrolyzed carbon particles produced via hydrothermal condensation mechanism in the absence of preferential exclusion agent.

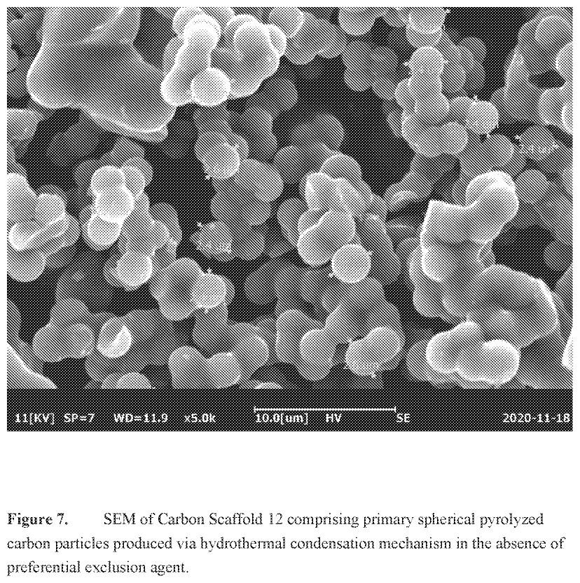

FIG. 8. SEM of various samples of primary spherical pyrolyzed carbon particles produced via hydrothermal condensation mechanism in the presence of preferential exclusion agent.

FIG. 9. SEM of Silicon-Carbon Composite 21.

### DETAILED DESCRIPTION

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### A. Primary Micron-Sized Porous Carbon Scaffold Particles

Traditional methods for preparing porous carbon materials from polymer precursors are known in the art. For example, methods for preparation of carbon materials are described in U.S. Pat. Nos. 7,723,262, 8,293,818, 8,404,384, 8,654,507, 8,916,296, 9,269,502, 10,590,277, and U.S. patent application Ser. No. 16/745,197, the full disclosures of which are hereby incorporated by reference in their entireties for all purposes. Employing those traditional methods where the particle is created by a form of abrasion milling to produce micronized carbon scaffold particles often results in broad particle size distributions, irregular and jagged particle morphology, and large fraction of fines that can present challenges and inconsistencies with handling, processing, and performance in a Li-ion battery system. The methods outlined herein describe the synthesis of micronized spherical carbon particles that forego the need for milling. In some embodiments the micronized spherical carbon particles are discrete, nonagglomerated particles.

In contrast to those traditional methods, herein we disclose a different approach that affords synthesizing primary sub-micron or micron-sized porous carbon scaffold particles. These particles exhibit spherical morphology. The primary micron-sized porous carbon particles can be created by hydrothermal carbonization of a reaction mixture. Accordingly, the reaction mixture is an aqueous milieu comprising a polyol and a preferential exclusion agent to facilitate preferential exclusion of the polyol to form spherical micron-sized domains within the aqueous milieu is subjected to elevated temperature sufficient to achieve a hydrothermal char (HTC). Suitable polyols include, but are not limited to, poly(ethylene glycols) (PEG), sorbitol, mannitol, maltitol, xylitol, isomalt, lactitol, sucrose, fructose, furfural, glucose, citric acid, starch, cellulose, allulose, xantham gum, gum arabic, alginates, chitin, chitosan, and combination thereof. In certain preferred embodiments, a reducing sugar is employed.

The concentration of the polyol can vary, for example from 0.001 M to 10 M, for example from 0.01 M to 10 M, for example from 0.1M to 10 M, for example from 0.5 M to 5 M. In certain embodiments, the reaction mixture may include a cross-linking agent. Suitable cross-linking agents include furfural, hexamethylenetetramine, formaldehyde, acetaldehyde, propionaldehyde, butyraldehyde, benzaldehyde, and combinations thereof. The concentration of the cross-linking agent can vary, for example from 0.001 M to 10 M, for example from 0.01M to 10 M, for example from 0.1 M to 10 M, alternatively may vary from 0.001 M to 5 M, for example 0.01 M to 5 M, for example from 0.1 M to 5 M, for example from 0.1 M to 1 M,

The reaction mixture may include one or more co-solvents including, but not limited to, alcohols, ethanol, methanol, tetrahydrofuran (THF), dimethylsulfoxide (DMSO), dimethylformamide (DMF), N-methyl pyrrolidone, glycol, glyme, alkanes, ethers, and combinations thereof. In some embodiments the reaction mixture may include one or more co-solvents including, but not limited to, ethanol, methanol, tetrahydrofuran (THF), dimethylsulfoxide (DMSO), dimethylformamide (DMF), N-methyl pyrrolidone, glycol, glyme, and combinations thereof. The volume ratio of co-solvent-to-water (V:V) may vary, for example from 0.001:1 to 1000:1, for example from 0.01:1 to 100:1, for example from 0.1 to 10:1.

The reaction mixture comprises a preferential exclusion agent. A preferential exclusion agent is defined as an agent that promotes the formation of spherical micron-sized domains within the aqueous milieu that are subsequently converted to HTC upon subjecting the reaction mixture to elevated temperature over time. The preferential exclusion agent has the property that its presence excludes the interaction of the polyol with the solvent, thus promoting polyol aggregates. Without being bound by theory, there are different possible mechanisms wherein the preferential exclusion agent affords the preferential exclusion, including, but not limited to, ionic interactions and hydrogen bonding interactions. Exemplary preferential exclusion agents include, but are not limited to, polyionic species, for example polyanionic species such as carboxymethylcellulose or poly(acrylic acid). Another exemplary preferential exclusion agents include ionic, non-ionic, or zwitterionic surfactants. Exemplary surfactants in this regard include Triton, SPAN, Pluronics, and the like.

The reaction mixture can be subjected to sufficient time and temperature to form spherical particles comprised of HTC. The time to produce the HTC may vary, for example from 1 h to 72 h. The temperature may vary, for example from 120 C to 300 C, for example from 140 C to 240 C, for example from 150 C to 250 C, for example from 160 C to 220 C. In certain embodiments, the reaction temperature is set at or below the temperature at which the surfactant begins to deteriorate or break down. In preferred embodiments, the temperature for producing the HTC is between 170 C and 210 C, or 180 C and 200 C, or 180 C and 220 C. The ramp from ambient temperature to the reaction temperature can vary, from example from 1 C/min to 100 C/min, for example 2 C/min to 50 C/min, for example 5 C/min to 20 C/min.

The reaction to produce the HTC is accomplished within a reactor, wherein the pressure can vary, for example from ambient pressure to a pressure above ambient, for example 0.1 psig to 1000 psig, for example 1 psig to 1000 psig, for example 1 psig to 500, for example 100 psig to 500 psig. In preferred embodiments, the reactor pressure is 120 psig to 300 psig, or 130 psig to 280 psig, for example 140 psig to 260 psig, for example 145 psig to 225 psig.

The reaction mixture can be stirred or otherwise mixed to promote the formation of spherical polyol-rich domains throughout the reaction mixture. This mixing can be accomplished in the reactor as known in the art, including stirring by magnetic bar or one or more sit paddles, sonication, vibration, reactor design such as rotary/stator reactor design, etc. The geometry of the reaction vessel can vary as known in the art, as can the reactor materials, for example a sealed stainless steel autoclave-type vessel with a Teflon liner. The reactor vessel in preferred modes can one or more ports for introduction of components at varying times during the course of the reaction. The reactor can be run in either batch or continuous fashion. The progression of the reaction can be monitored by withdrawing samples and analyzing various properties such as viscosity, conductivity, absorbance (visible and/or UV wavelengths), size of suspended particles (as known in the art, for example by laser light scattering). Alternatively, the reaction progress can be monitored in line.

In certain embodiments, the aqueous reaction milieu exhibits an acidic pH, for example pH ranging from pH 2 to pH 6, for example pH 2 to pH 4, or pH 4 to pH 5, or pH 5 to pH 6. In certain other embodiments, the aqueous reaction milieu exhibits a basic pH, for example pH ranging from pH 8 to pH 14, for example pH 8 to pH 12, or pH 8 to pH 10, or pH 9 to pH 10. In other embodiments, the aqueous reaction milieu exhibits a neutral pH, for example pH ranging from pH 6 to pH 8, for example pH 6 to pH 7, for example pH 7 to pH 8. The pH can be adjusted by additional of acid and/or base as known in the art. In some embodiments, a volatile acid, such as acetic acid, and/or a volatile base, such as ammonium acetate, can be employed to adjust pH. In some embodiments, a buffer system can be used as known in the art to control the pH of the aqueous reaction milieu. In some embodiments, the agent(s) employed to adjust and/or control pH of the aqueous reaction milieu can also act as a preferential exclusion agent(s), for example, amino acid(s).

The conductivity of the aqueous reaction milieu can vary, for example from 0-1000 mS/cm. The oxidation-reduction potential (ORP) of the aqueous reaction milieu can vary, for example from +2.87 V to −3.05 V. The viscosity of the aqueous reaction milieu can vary, for example from 0.1 cP to 1000 cP.

In some embodiments, the aqueous reaction milieu can comprise catalyst particles, including, but not limited to, metals, such as lithium. Other exemplary catalysts in this regard include amorphous carbon, nano-graphite, carbon black, nano-sized and/or nano-structured carbon such as carbon nanotubes, and combinations thereof. In certain embodiments, the catalysts may be a silane/siloxane cross linking agent, persulfate, hydroxide, or combination thereof.

In certain embodiments, the aqueous reaction milieu comprises an electrochemical modifier. For example, in some embodiments, an electrochemical modifier in the form of metal particles, metal paste, metal salt, metal oxide or molten metal can be dissolved or suspended into the mixture from which the HTC is produced

In some embodiments, the electrochemical modifier is a lithium salt, for example, but not limited to, lithium fluoride, lithium chloride, lithium carbonate, lithium hydroxide, lithium benzoate, lithium bromide, lithium formate, lithium hexafluorophosphate, lithium iodate, lithium iodide, lithium perchlorate, lithium phosphate, lithium sulfate, lithium tetraborate, lithium tetrafluoroborate, and combinations thereof.

In certain embodiments, the electrochemical modifier comprises a metal, and exemplary species includes, but are not limited to aluminum isoproproxide, manganese acetate, nickel acetate, iron acetate, tin chloride, silicon chloride, and combinations thereof. In certain embodiments, the electrochemical modifier is a phosphate compound, including but not limited to phytic acid, phosphoric acid, ammonium dihydrogenphosphate, and combinations thereof. In certain embodiments, the electrochemical modifier comprises silicon, and exemplary species includes, but are not limited to silicon powders, silicon nanotubes, polycrystalline silicon, nanocrystalline silicon, amorpohous silicon, porous silicon, nano sized silicon, nano-featured silicon, nano-sized and nano-featured silicon, silicyne, and black silicon, and combinations thereof.

Electrochemical modifiers can be combined with a variety of polymer systems through either physical mixing or chemical reactions with latent (or secondary) polymer functionality. Examples of latent polymer functionality include, but are not limited to, epoxide groups, unsaturation (double and triple bonds), acid groups, alcohol groups, amine groups, basic groups. Crosslinking with latent functionality can occur via heteroatoms (e.g. vulcanization with sulfur, acid/base/ring opening reactions with phosphoric acid), reactions with organic acids or bases (described above), coordination to transition metals (including but not limited to Ti, Cr, Mn, Fe, Co, Ni, Cu, Zn, Zr, Nb, Mo, Ag, Au), ring opening or ring closing reactions (rotaxanes, spiro compounds, etc.).

Following creation of the HTC, the resulting plurality of particles can be removed from the aqueous milieu by methods known in the art such as filtration, centrifugation, sedimentation, etc. and any residual water can be removed by subjecting the material to heat and/or vacuum to yield a dried HTC. The dried HTC can be pyrolyzed to yield a plurality of spherical primary sub-micron or micron-sized porous pyrolyzed carbon particles. The temperature and dwell time of pyrolysis can be varied, for example the dwell time van vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200 to 300 C, from 250 to 350 C, from 350 C to 450 C, from 450 C to 550 C, from 540 C to 650 C, from 650 C to 750 C, from 750 C to 1050 C, from 750 C to 850 C, from 850 C to 950 C, from 950 C to 1050 C, from 1050 C to 1150 C, from 1150 C to 1250 C. The pyrolysis can be accomplished in an inert gas, for example nitrogen, or argon.

In some embodiments, an alternate gas is used to further accomplish carbon activation to yield a plurality of primary porous carbon particles of sufficient porosity to serve as a scaffold for subsequent CVI reaction to produce a silicon-carbon composite material. In certain embodiments, pyrolysis and activation are combined. Suitable gases for accomplishing carbon activation can be defined as activation gases, including, but not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example can vary from 200 to 300 C, from 250 to 350 C, from 350 C to 450 C, from 450 C to 550 C, from 540 C to 650 C, from 650 C to 750 C, from 750 C to 850 C, from 750 C to 1050 C, from 850 C to 950 C, from 950 C to 1050 C, from 1050 C to 1150 C, from 1150 C to 1250 C.

Either prior to the pyrolysis, and/or after pyrolysis, and/or after activation, the carbon may be subjected to a particle size reduction. The particle size reduction can be accomplished by a variety of techniques known in the art, for example by jet milling in the presence of various gases including air, nitrogen, argon, helium, supercritical steam, and other gases known in the art. Other particle size reduction methods, such as grinding, ball milling, jet milling, water jet milling, and other approaches known in the art are also envisioned. In preferred embodiments, however, no addition particle size reduction method is conducted since the HTC material is already produced as a plurality of primary particles that are in a suitable range for use as a scaffold for producing the silicon-carbon composite.

The particle size and particle size distribution for the primary porous carbon scaffold particles can be measured by a variety of techniques known in the art, and can be described based on fractional volume. In this regard, the Dv50 of the carbon scaffold may be between 10 nm and 10 mm, for example between 100 nm and 1 mm, for example between 1 micrometer (“μm”) and 100 μm, for example between 2 μm and 50 μm, example between 3 μm and 30 μm, example between 4 μm and 20 μm, example between 5 μm and 10 μm. In certain embodiments, the Dv50 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv100 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv99 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv90 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv0 is greater than 10 nm, for example greater than 100 nm, for example greater than 500 nm, for example greater than 1 μm, for example greater than 2 μm, for example greater than 5 μm, for example greater than 10 μm. In certain embodiments, the Dv1 is greater than 10 nm, for example greater than 100 nm, for example greater than 500 nm, for example greater than 1 μm, for example greater than 2 μm, for example greater than 5 μm, for example greater than 10 μm. In certain embodiments, the Dv10 is greater than 10 nm, for example greater than 100 nm, for example greater than 500 nm, for example greater than 1 μm, for example greater than 2 μm, for example greater than 5 μm, for example greater than 10 μm.

In some embodiments, the surface area of the porous carbon scaffold can comprise a surface area greater than 400 m2/g, for example greater than 500 m2/g, for example greater than 750 m2/g, for example greater than 1000 m2/g, for example greater than 1250 m2/g, for example greater than 1500 m2/g, for example greater than 1750 m2/g, for example greater than 2000 m2/g, for example greater than 2500 m2/g, for example greater than 3000 m2/g. In other embodiments, the surface area of the porous carbon scaffold can be less than 500 m2/g. In some embodiments, the surface area of the porous carbon scaffold is between 200 and 500 m2/g. In some embodiments, the surface area of the porous carbon scaffold is between 100 and 200 m2/g. In some embodiments, the surface area of the porous carbon scaffold is between 50 and 100 m2/g. In some embodiments, the surface area of the porous carbon scaffold is between 10 and 50 m2/g. In some embodiments, the surface area of the porous carbon scaffold can be less than 10 m2/g.

In some embodiments, the pore volume of the primary porous carbon scaffold particles is greater than 0.4 cm3/g, for example greater than 0.5 cm3/g, for example greater than 0.6 cm3/g, for example greater than 0.7 cm3/g, for example greater than 0.8 cm3/g, for example greater than 0.9 cm3/g, for example greater than 1.0 cm3/g, for example greater than 1.1 cm3/g, for example greater than 1.2 cm3/g, for example greater than 1.4 cm3/g, for example greater than 1.6 cm3/g, for example greater than 1.8 cm3/g, for example greater than 2.0 cm3/g. In other embodiments, the pore volume of the porous silicon scaffold is less than 0.5 cm3, for example between 0.1 cm3/g and 0.5 cm3/g. In certain other embodiments, the pore volume of the porous silicon scaffold is between 0.01 cm3/g and 0.1 cm3/g. In still further embodiments, the pore volume may be between 0.001 cm3/g and 0.01 cm3/g.

In some other embodiments, the primary porous carbon scaffold particles comprise amorphous activated carbon with a pore volume between 0.2 and 2.0 cm3/g. In certain embodiments, the carbon is an amorphous activated carbon with a pore volume between 0.4 and 1.5 cm3/g. In certain embodiments, the carbon is an amorphous activated carbon with a pore volume between 0.5 and 1.2 cm3/g. In certain embodiments, the carbon is an amorphous activated carbon with a pore volume between 0.6 and 1.0 cm3/g.

In some other embodiments, the primary porous carbon scaffold particles comprise a tap density of less than 1.0 g/cm3, for example less than 0.8 g/cm3, for example less than 0.6 g/cm3, for example less than 0.5 g/cm3, for example less than 0.4 g/cm3, for example less than 0.3 g/cm3, for example less than 0.2 g/cm3, for example less than 0.1 g/cm3.

The surface functionality of the primary porous carbon scaffold particles can vary. One property which can be predictive of surface functionality is the pH of the porous carbon scaffold. The presently disclosed porous carbon scaffolds comprise pH values ranging from less than 1 to about 14, for example less than 5, from 5 to 8 or greater than 8. In some embodiments, the pH of the porous carbon is less than 4, less than 3, less than 2 or even less than 1. In other embodiments, the pH of the porous carbon is between about 5 and 6, between about 6 and 7, between about 7 and 8 or between 8 and 9 or between 9 and 10. In still other embodiments, the pH is high and the pH of the porous carbon ranges is greater than 8, greater than 9, greater than 10, greater than 11, greater than 12, or even greater than 13.

The pore volume distribution of the primary porous carbon scaffold particles can vary. For example, the % micropores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable micropore volume in the porous carbon scaffold.

The mesopores comprising the primary porous carbon scaffold particles can vary. For example, the % mesopores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable mesopore volume in the porous carbon scaffold.

In some embodiments, the pore volume distribution of the porous carbon scaffold comprises more than 50% macropores, for example more than 60% macropores, for example more than 70% macropores, for example more than 80% macropores, for example more than 90% macropores, for example more than 95% macropores, for example more than 98% macropores, for example more than 99% macropores, for example more than 99.5% macropores, for example more than 99.9% macropores.

In certain preferred embodiments, the pore volume of the primary porous carbon scaffold particles comprises a blend of micropores, mesopores, and macropores. Accordingly, in certain embodiments, the porous carbon scaffold comprises 0-20% micropores, 30-70% mesopores, and less than 10% macropores. In certain other embodiments, the porous carbon scaffold comprises 0-20% micropores, 0-20% mesopores, and 70-95% macropores. In certain other embodiments, the porous carbon scaffold comprises 20-50% micropores, 50-80% mesopores, and 0-10% macropores. In certain other embodiments, the porous carbon scaffold comprises 40-60% micropores, 40-60% mesopores, and 0-10% macropores. In certain other embodiments, the porous carbon scaffold comprises 80-95% micropores, 0-10% mesopores, and 0-10% macropores. In certain other embodiments, the porous carbon scaffold comprises 0-10% micropores, 30-50% mesopores, and 50-70% macropores. In certain other embodiments, the porous carbon scaffold comprises 0-10% micropores, 70-80% mesopores, and 0-20% macropores. In certain other embodiments, the porous carbon scaffold comprises 0-20% micropores, 70-95% mesopores, and 0-10% macropores. In certain other embodiments, the porous carbon scaffold comprises 0-10% micropores, 70-95% mesopores, and 0-20% macropores.

In certain embodiments, the % of pore volume in the primary porous carbon scaffold particles representing pores between 100 and 1000 A (10 and 100 nm) comprises greater than 30% of the total pore volume, for example greater than 40% of the total pore volume, for example greater than 50% of the total pore volume, for example greater than 60% of the total pore volume, for example greater than 70% of the total pore volume, for example greater than 80% of the total pore volume, for example greater than 90% of the total pore volume, for example greater than 95% of the total pore volume, for example greater than 98% of the total pore volume, for example greater than 99% of the total pore volume, for example greater than 99.5% of the total pore volume, for example greater than 99.9% of the total pore volume.

In certain embodiments, the pycnometry density of the primary porous carbon scaffold particles ranges from about 1 g/cc to about 3 g/cc, for example from about 1.5 g/cc to about 2.3 g/cc. In other embodiments, the skeletal density ranges from about 1.5 cc/g to about 1.6 cc/g, from about 1.6 cc/g to about 1.7 cc/g, from about 1.7 cc/g to about 1.8 cc/g, from about 1.8 cc/g to about 1.9 cc/g, from about 1.9 cc/g to about 2.0 cc/g, from about 2.0 cc/g to about 2.1 cc/g, from about 2.1 cc/g to about 2.2 cc/g or from about 2.2 cc/g to about 2.3 cc/g, from about 2.3 cc to about 2.4 cc/g, for example from about 2.4 cc/g to about 2.5 cc/g.

### B. Silicon Production Via Chemical Vapor Infiltration (CVI)

Chemical vapor deposition (CVD) is a process wherein a substrate provides a solid surface comprising the first component of the composite, and the gas thermally decomposes on this solid surface to provide the second component of composite. Such a CVD approach can be employed, for instance, to create Si—C composite materials wherein the silicon is coating on the outside surface of silicon particles. Alternatively, chemical vapor infiltration (CVI) is a process wherein a substrate provides a porous scaffold comprising the first component of the composite, and the gas thermally decomposes on into the porosity (into the pores) of the porous scaffold material to provide the second component of composite.

In an embodiment, silicon is created within the pores of the porous carbon scaffold by subjecting the porous carbon particles to a silicon containing precursor gas at elevated temperature and the presence of a silicon-containing gas, preferably silane, in order to decompose said gas into silicon. The silicon containing precursor gas can be mixed with other inert gases, for example, nitrogen gas. The temperature and time of processing can be varied, for example the temperature can be between 200 and 900 C, for example between 200 and 250 C, for example between 250 and 300 C, for example between 300 and 350 C, for example between 300 and 400 C, for example between 350 and 450 C, for example between 350 and 400 C, for example between 400 and 500 C, for example between 500 and 600 C, for example between 600 and 700 C, for example between 700 and 800 C, for example between 800 and 900 C, for example between 600 and 1100 C.

The mixture of gas can comprise between 0.1 and 1% silane and remainder inert gas. Alternatively, the mixture of gas can comprise between 1% and 10% silane and remainder inert gas. Alternatively, the mixture of gas can comprise between 10% and 20% silane and remainder inert gas. Alternatively, the mixture of gas can comprise between 20% and 50% silane and remainder inert gas. Alternatively, the mixture of gas can comprise above 50% silane and remainder inert gas. Alternatively, the gas can essentially be 100% silane gas. Suitable inert gases include, but are not limited to, hydrogen, nitrogen, argon, and combinations thereof.

The pressure for the CVI process can be varied. In some embodiments, the pressure is atmospheric pressure. In some embodiments, the pressure is below atmospheric pressure. In some embodiments, the pressure is above atmospheric pressure.

### C. Physico- and Electrochemical Properties of Silicon-Carbon Composite

While not wishing to be bound by theory, it is believed that the nano sized silicon achieved as a result of filling in certain, desired pore volume structure of the porous carbon scaffold (for instance, silicon filling pores in the range of 5 to 1000 nm, or other range as disclosed elsewhere herein), along with the advantageous properties of the other components of the composite, including low surface area, low pycnometry density, yield composite materials having different and advantageous properties, for instance electrochemical performance when the composite comprises an anode of a lithium ion energy storage device.

In certain embodiments, the embedded silicon particles embedded within the composite comprise nano-sized features. The nano-sized features can have a characteristic length scale of preferably less than 1 μm, preferably less than 300 nm, preferably less than 150 nm, preferably less than 100 μm, preferably less than 50 nm, preferably less than 30 nm, preferably less than 15 nm, preferably less than 10 nm, preferably less than 5 nm.

In certain embodiments, the silicon embedded within the composite is spherical in shape. In certain other embodiments, the porous silicon particles are non-spherical, for example rod-like, or fibrous in structure. In some embodiments, the silicon exists as a layer coating the inside of pores within the porous carbon scaffold. The depth of this silicon layer can vary, for example the depth can between 5 nm and 10 nm, for example between 5 nm and 20 nm, for example between 5 nm and 30 nm, for example between 5 nm and 33 nm, for example between 10 nm and 30 nm, for example between 10 nm and 50 nm, for example between 10 nm and 100 nm, for example between 10 and 150 nm, for example between 50 nm and 150 nm, for example between 100 and 300 nm, for example between 300 and 1000 nm.

In some embodiments, the silicon embedded within the composite is nano sized, and resides within pores of the porous carbon scaffold. For example, the embedded silicon can be impregnated, deposited by CVI, or other appropriate process into pores within the porous carbon particle comprising pore sizes between 5 and 1000 nm, for example between 10 and 500 nm, for example between 10 and 200 nm, for example between 10 and 100 nm, for example between 33 and 150 nm, for example between and 20 and 100 nm. Other ranges of carbon pores sizes with regards to fractional pore volume, whether micropores, mesopores, or macropores, are also envisioned.

In some embodiments, the carbon scaffold pore volume distribution can be described as the number or volume distribution of pores as determined as known in the art based on gas sorption analysis, for example nitrogen gas sorption analysis. In some embodiments the pore size distribution can be expressed in terms of the pore size at which a certain fraction of the total pore volume resides at or below. For example, the pore size at which 10% of the pores reside at or below can be expressed at DPv10.

The DPv10 for the porous carbon scaffold can vary, for example DPv10 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm.

The DPv50 for the porous carbon scaffold can vary, for example DPv50 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm. In other embodiments, the DPv50 is between 2 and 100, for example between 2 and 50, for example between 2 and 30, for example between 2 and 20, for example between 2 and 15, for example between 2 and 10.

The DPv90 for the porous carbon scaffold can vary, for example DPv90 can be between 0.01 nm and 100 nm, for example between 0.1 nm and 100 nm, for example between 1 nm and 100 nm, for example between 1 nm and 50 nm, for example between 1 nm and 50 nm, for example between 1 nm and 40 nm, for example between 1 nm and 30 nm, for example between 1 nm and 10 nm, for example between 1 nm and 5 nm. In other embodiments, the DPv50 is between 2 nm and 100 nm, for example between 2 nm and 50 nm, for example between 2 nm and 30 nm, for example between 2 nm and 20 nm, for example between 2 nm and 15 nm, for example between 2 nm and 10 nm.

In some embodiments, the DPv90 is less than 100 nm, for example less than 50 nm, for example less than 40 nm, for example less than 30 nm, for example less than 20 nm, for example less than 15 nm, for example less than 10 nm. In some embodiments, the carbon scaffold comprises a pore volume with greater than 70% micropores (and DPv90 less than 100 nm, for example DPv90 less than 50 nm, for example DPv90 less than 40 nm, for example DPv90 less than 30 nm, for example DPv90 less than 20 nm, for example DPv90 less than 15 nm, for example DPv90 less than 10 nm, for example DPv90 less than 5 nm, for example DPv90 less than 4 nm, for example DPv90 less than 3 nm. In other embodiments, the carbon scaffold comprises a pore volume with greater than 80% micropores and DPv90 less than 100 nm, for example DPv90 less than 50 nm, for example DPv90 less than 40 nm, for example DPv90 less than 30 nm, for example DPv90 less than 20 nm, for example DPv90 less than 15 nm, for example DPv90 less than 10 nm, for example DPv90 less than 5 nm, for example DPv90 less than 4 nm, for example DPv90 less than 3 nm.

The DPv99 for the porous carbon scaffold can vary, for example DPv99 can be between 0.01 nm and 1000 nm, for example between 0.1 nm and 1000 nm, for example between 1 nm and 500 nm, for example between 1 nm and 200 nm, for example between 1 nm and 150 nm, for example between 1 nm and 100 nm, for example between 1 nm and 50 nm, for example between 1 nm and 20 nm. In other embodiments, the DPv99 is between 2 nm and 500 nm, for example between 2 nm and 200 nm, for example between 2 nm and 150 nm, for example between 2 nm and 100 nm, for example between 2 nm and 50 nm, for example between 2 nm and 20 nm, for example between 2 nm and 15 nm, for example between 2 nm and 10 nm.

Embodiments of the composite with extremely durable intercalation of lithium disclosed herein improves the properties of any number of electrical energy storage devices, for example lithium ion batteries. In some embodiments, the silicon-carbon composite disclosed herein exhibits a Z less than 10, for example a Z less than 5, for example a Z less than 4, for example a Z less than 3, for example a Z less than 2, for example a Z less than 1, for example a Z less than 0.1, for example a Z less than 0.01, for example a Z less than 0.001. In certain embodiments, the Z is zero.

In certain preferred embodiment, the silicon-carbon composite comprises desirably low Z in combination with another desired physicochemical and/or electrochemical property or in combination with more than one other desired physicochemical and/or electrochemical properties. Table 1 provides a description of certain embodiments for combination of properties for the silicon-carbon composite. Surface area can be determined as known in the art, for example, by nitrogen gas sorption analysis. Silicon content can be determined as known in the art, for example by TGA. The property Z can be determined from TGA according to the current disclosure. First cycle efficiency can be determined as known in the art, for example calculated based on first cycle charge and discharge capacity in a full cell or half cell. For example, first cycle efficiency can be determined in a half cell for the voltage window of 5 mV to 0.8 V, or alternatively, 5 mV to 1.5 V. Reversible capacity can be described as the maximum reversible capacity or maximum capacity, and can be determined as known in the art, for example in a half cell for the voltage window of 5 mV to 0.8 V, or alternatively, 5 mV to 1.5 V.

TABLE 1
Embodiments for silicon-carbon composite with embodied properties.

| | In some embodiments the silicon-carbon composite comprises . . . |
|---|---|
| Z | <10, <5, <4, <3, <2, <1, <0.1, <0.01, <0.01, 0 |
| Surface Area | <100 m2/g, <50 m2/g, <30 m2/g, <20 m2/g, <10 m2/g, <5 m2/g, <4 m2/g, |
| | <3 m2/g, <2 m2/g, <1 m2/g; |
| First Cycle | >75%, >80%, >85%, >90%, >91%, >92%, >93%, >94%, >95%, >96%, >97%, |
| Efficiency | >98%, >99%; |
| Reversible | >1300 mAh/g, >1600 mAh/g, >1700 mAh/g, >1800 mAh/g, >1900 mAh/g, |
| Capacity | >2000 mAh/g, >2100 mAh/g, >2200 mAh/g, >2300 mAh/g, >2400 mAh/g, |
| | >2500 mAh/g, >2600 mAh/g, >2700 mAh/g, >2800 mAh/g, >2900 mAh/g, |
| | >3000 mAh/g; and/or |
| Silicon Content | 10%-90%, 15-85%, 20%-80%, 30%-70%, 40%-60%. |
| by weight | |

According to Table 1, the silicon-carbon composite may comprise combinations of various properties. For example, the silicon-carbon composite may comprise a Z less than 10, surface area less than 100 m2/g, a first cycle efficiency greater than 80%, and a reversible capacity of at least 1300 mAh/g. For example, the silicon-carbon composite may comprise a Z less than 10, surface area less than 100 m2/g, a first cycle efficiency greater than 80%, and a reversible capacity of at least 1600 mAh/g. For example, the silicon-carbon composite may comprise a Z less than 10, surface area less than 20 m2/g, a first cycle efficiency greater than 85%, and a reversible capacity of at least 1600 mAh/g. For example, the silicon-carbon composite may comprise a Z less than 10, surface area less than 10 m2/g, a first cycle efficiency greater than 85%, and a reversible capacity of at least 1600 mAh/g. For example, the silicon-carbon composite may comprise a Z less than 10, surface area less than 10 m2/g, a first cycle efficiency greater than 90%, and a reversible capacity of at least 1600 mAh/g. For example, the silicon-carbon composite may comprise a Z less than 10, surface area less than 10 m2/g, a first cycle efficiency greater than 90%, and a reversible capacity of at least 1800 mAh/g.

In some embodiments the TGA onset temperature is higher than similar silicon-carbon composites made from non-polyol precursor. Without being bound by theory, a higher TGA onset temperature may result in less gassing of the silicon-carbon composite when used as an anode material in a battery anode (e.g., lithium-ion battery anode or lithium-silicon battery anode).

TABLE 2
TGA onset temperature for silicon-carbon composite.

| | | TGA Onset |
|---|---|---|
| Sample | Polyol:Surfactant Ratio | Temperature (° C.) |
| Non-polyol precursor 1 | N/A | 409 |
| Non-polyol precursor 2 | N/A | 450 |
| Non-polyol precursor 3 | N/A | 369 |
| Polyol derived SiC-1 | 974:1 | 652.3 |
| Polyol derived SiC-2 | 1013.5:1 | 654.0 |
| Polyol derived SiC-3 | 1010:1 | 667.4 |
| Polyol derived SiC-4 | N/A (no surfactant used) | 668.3 |
| Polyol derived SiC-5 | N/A (no surfactant used) | 670.8 |
| Polyol derived SiC-6 | 974.0:1 | 656.1 |

In some embodiments, the TGA onset temperature of the silicon-carbon composite is greater than 600° C. In still other embodiments the TGA onset temperature of the silicon-carbon composite is between 300° C. and 400° C.; 400° ° C. to 500° C.; or 500° C. and 600° C. In some embodiments the TGA onset temperature of the silicon-carbon composite is greater than 600° C.

The silicon-carbon composite can comprise a combination of the aforementioned properties, in addition to also comprising a carbon scaffold comprising properties also described within this proposal. Accordingly, Table 2 provides a description of certain embodiments for combination of properties for the silicon-carbon composite.

TABLE 3
Embodiments for silicon-carbon composite with embodied properties.

| | In some embodiments the silicon-carbon composite comprises . . . |
|---|---|
| Z | <10, <5, <4, <3, <2, <1, <0.1, <0.01, <0.01, 0 |
| Surface Area | <100 m2/g, <50 m2/g, <30 m2/g, <20 m2/g, <10 m2/g, <5 |
| | m2/g, <4 m2/g, <3 m2/g, <2 m2/g, <1 m2/g; |
| First Cycle | >75%, >80%, >85%, >90%, >91%, >92%, >93%, >94%, >95%, |
| Efficiency | >96%, >97%, >98%, >99%; |
| Reversible | >1300 mAh/g, >1600 mAh/g, >1700 mAh/g, >1800 mAh/g, |
| Capacity | >1900 mAh/g, >2000 mAh/g, >2100 mAh/g, >2200 mAh/g, |
| | >2300 mAh/g, >2400 mAh/g, >2500 mAh/g, >2600 mAh/g, |
| | >2700 mAh/g, >2800 mAh/g, >2900 mAh/g, >3000 mAh/g; |
| Average | ≥0.9969, ≥0.9970, ≥0.9975, ≥0.9980, ≥0.9985, ≥0.9990, ≥0.9995, |
| Coulombic | ≥0.9999 |
| efficiency | |
| Silicon Content | 10%-90%, 15-85%, 20%-80%, 30%-70%, 40%-60%, 30%-60% |
| by weight | |
| Carbon | 0.1-1.5 cm3/g, 0.2-1.2 cm3/g, 0.3-1.1 cm3/g, 0.4-1.0 cm3/g, |
| Scaffold pore | 0.4-1.0 cm3/g, 0.5-1.0 cm3/g, 0.6-1.0 cm3/g, 0.5-0.9 cm3/g, |
| volume | 0.4-1.0 cm3/g, >0.1 cm3/g, >0.2 cm3/g, >0.4 cm3/g, >0.6 cm3/g, |
| | >0.8 cm3/g; |
| % silicon | 15%-25%, 25%-35%, 20%-40%, 25%-50%, 30%-70%, |
| content | 30%-60%, 60%-80%, 80%-100%; |
| Scaffold pore | <1 nm, 1-5 nm, 5-1000 nm, 10-500 nm, 10-200 nm, 10-100 nm, |
| size range | 33-150 nm, 20-100 nm |
| Percentage of | >20%/>30%/>30%, <10/>30/>30, <5/>30/>30, <5/>40/>40, |
| microporosity/ | <1/>40/>40, <10/>70/>20, <10/>20/>70, >10/>10/>80, |
| mesoporosity/ | <10/>80/>10, <5/>70/>20, <5/>20/>70, <5/>5/>80, <5/>80/>10, |
| microporosity | >80%/<20%/<20%, >70/<30/<10, >70/<30/<5, |
| expressed as | >70/<20/<10, >70/<10/<10, >70/<10/<5, >70/<5/<5, |
| percentage of | >80/<20/<10, >80/<20/<5, >80/<20/<1, >80/<10/<10, |
| total pore | >80/<10/<5, >80/<10/<1, >90/<10/<10, >90/<10/<5, >90/<10/<1, |
| volume | >90/<5/<1, >95/<5/<5, >90/<5/<1 |

As used in herein, the percentage “microporosity,” “mesoporosity” and “macroporosity” refers to the percent of micropores, mesopores and macropores, respectively, as a percent of total pore volume. For example, a carbon scaffold having 90% microporosity is a carbon scaffold where 90% of the total pore volume of the carbon scaffold is formed by micropores.

According to Table 3, the silicon-carbon composite may comprise combinations of various properties. For example, the silicon-carbon composite may comprise a Z less than 10, surface area less than 100 m2/g, a first cycle efficiency greater than 80%, a reversible capacity of at least 1600 mAh/g, a silicon content of 15%-85%, a carbon scaffold total pore volume of 0.2-1.2 cm3/g wherein the scaffold pore volume comprises >80% micropores, <20% mesopores, and <10% macropores. For example, the silicon-carbon composite may comprise a Z less than 10, surface area less than 20 m2/g, a first cycle efficiency greater than 85%, and a reversible capacity of at least 1600 mAh/g, a silicon content of 15%-85%, a carbon scaffold total pore volume of 0.2-1.2 cm3/g wherein the scaffold pore volume comprises >80% micropores, <20% mesopores, and <10% macropores. For example, the silicon-carbon composite may comprise a Z less than 10, surface area less than 10 m2/g, a first cycle efficiency greater than 85%, and a reversible capacity of at least 1600 mAh/g, a silicon content of 15%-85%, a carbon scaffold total pore volume of 0.2-1.2 cm3/g wherein the scaffold pore volume comprises >80% micropores, <20% mesopores, and <10% macropores. For example, the silicon-carbon composite may comprise a Z less than 10, surface area less than 10 m2/g, a first cycle efficiency greater than 90%, and a reversible capacity of at least 1600 mAh/g, a silicon content of 15%-85%, a carbon scaffold total pore volume of 0.2-1.2 cm3/g wherein the scaffold pore volume comprises >80% micropores, <20% mesopores, and <10% macropores. For example, the silicon-carbon composite may comprise a Z less than 10, surface area less than 10 m2/g, a first cycle efficiency greater than 90%, and a reversible capacity of at least 1800 mAh/g, a silicon content of 15%-85%, a carbon scaffold total pore volume of 0.2-1.2 cm3/g wherein the scaffold pore volume comprises >80% micropores, <20% mesopores, and <10% macropores.

Also, according to Table 3, the silicon-carbon composite may comprise a carbon scaffold with >80% micropores, silicon content of 30-60%, average Coulombic efficiency of ≥0.9969, and Z<10. For example, the silicon-carbon composite may comprise a carbon scaffold with >80% micropores, silicon content of 30-60%, average Coulombic efficiency of ≥0.9970, and Z<10. For example, the silicon-carbon composite may comprise a carbon scaffold with >80% micropores, silicon content of 30-60%, average Coulombic efficiency of ≥0.9975, and Z<10. For example, the silicon-carbon composite may comprise a carbon scaffold with >80% micropores, silicon content of 30-60%, average Coulombic efficiency of ≥0.9980, and Z<10. For example, the silicon-carbon composite may comprise a carbon scaffold with >80% micropores, silicon content of 30-60%, average Coulombic efficiency of ≥0.9985, and Z<10. For example, the silicon-carbon composite may comprise a carbon scaffold with >80% micropores, silicon content of 30-60%, average Coulombic efficiency of ≥0.9990, and Z<10. For example, the silicon-carbon composite may comprise a carbon scaffold with >80% micropores, silicon content of 30-60%, average Coulombic efficiency of ≥0.9995, and Z<10. For example, the silicon-carbon composite may comprise a carbon scaffold with >80% micropores, silicon content of 30-60%, average Coulombic efficiency of ≥0.9970, and Z<10. For example, the silicon-carbon composite may comprise a carbon scaffold with >80% micropores, silicon content of 30-60%, average Coulombic efficiency of ≥0.9999, and Z<10.

Without being bound by theory, the filling of silicon within the pores of the porous carbon traps porosity within the porous carbon scaffold particle, resulting in inaccessible volume, for example volume that is inaccessible to nitrogen gas. Accordingly, the silicon-carbon composite material may exhibit a pycnometry density of less than 2.1 g/cm3, for example less than 2.0 g/cm3, for example less than 1.9 g/cm3, for example less than 1.8 g/cm3, for example less than 1.7 g/cm3, for example less than 1.6 g/cm3, for example less than 1.4 g/cm3, for example less than 1.2 g/cm3, for example less than 1.0 g/cm3.

In some embodiments, the silicon-carbon composite material may exhibit a pycnometry density between 1.7 g·3 and 2.1 g/cm3, for example between 1.7 g·3 and 1.8 g/cm3, between 1.8 g·3 and 1.9 g/cm3, for example between 1.9 g·3 and 2.0 g/cm3, for example between 2.0 g·3 and 2.1 g/cm3. In some embodiments, the silicon-carbon composite material may exhibit a pycnometry density between 1.8 g·3 and 2.1 g/cm3. In some embodiments, the silicon-carbon composite material may exhibit a pycnometry density between 1.8 g·3 and 2.0 g/cm3. In some embodiments, the silicon-carbon composite material may exhibit a pycnometry density between 1.9 g·3 and 2.1 g/cm3.

The pore volume of the composite material exhibiting extremely durable intercalation of lithium can range between 0.01 cm3/g and 0.2 cm3/g. In certain embodiments, the pore volume of the composite material can range between 0.01 cm3/g and 0.15 cm3/g, for example between 0.01 cm3/g and 0.1 cm3/g, for example between 0.01 cm3/g and 0.05 cm2/g.

The particle size distribution of the composite material exhibiting extremely durable intercalation of lithium is important to both determine power performance as well as volumetric capacity. As the packing improves, the volumetric capacity may increase. In one embodiment the distributions are either Gaussian with a single peak in shape, bimodal, or polymodal (>2 distinct peaks, for example trimodal). The properties of particle size of the composite can be described by the DO (smallest particle in the distribution), Dv50 (average particle size) and Dv100 (maximum size of the largest particle). The optimal combined of particle packing and performance will be some combination of the size ranges below. The particle size reduction in the such embodiments can be carried out as known in the art, for example by jet milling in the presence of various gases including air, nitrogen, argon, helium, supercritical steam, and other gases known in the art.

In one embodiment the Dv0 of the composite material can range from 1 nm to 5 microns. In another embodiment the Dv0 of the composite ranges from 5 nm to 1 micron, for example 5-500 nm, for example 5-100 nm, for example 10-50 nm. In another embodiment the Dv0 of the composite ranges from 500 nm to 2 microns, or 750 nm to 1 μm, or 1-2 μm. microns to 2 microns. In other embodiments, the Dv0 of the composite ranges from 2-5 μm, or >5 μm.

In some embodiments the Dv50 of the composite material ranges from 5 nm to 20 μm. In other embodiments the Dv50 of the composite ranges from 5 nm to 1 μm, for example 5-500 nm, for example 5-100 nm, for example 10-50 nm. In another embodiment the Dv50 of the composite ranges from 500 nm to 2 μm, 750 nm to 1 μm, 1-2 μm. In still another embodiments, the Dv50 of the composite ranges from 1 to 1000 μm, for example from 1-100 μm, for example from 1-10 μm, for example 2-20 μm, for example 3-15 μm, for example 4-8 μm. In certain embodiments, the Dv50 is >20 μm, for example >50 μm, for example >100 μm.

The span (Dv50)/(Dv90−Dv10), wherein Dv10, Dv50 and Dv90 represent the particle size at 10%, 50%, and 90% of the volume distribution, can be varied from example from 100 to 10, from 10 to 5, from 5 to 2, from 2 to 1; in some embodiments the span can be less than 1. In certain embodiments, the composite comprising carbon and porous silicon material particle size distribution can be multimodal, for example, bimodal, or trimodal.

The surface functionality of the presently disclosed the composite material exhibiting extremely durable intercalation of lithium may be altered to obtain the desired electrochemical properties. One property which can be predictive of surface functionality is the pH of the composite materials. The presently disclosed composite materials comprise pH values ranging from less than 1 to about 14, for example less than 5, from 5 to 8 or greater than 8. In some embodiments, the pH of the composite materials is less than 4, less than 3, less than 2 or even less than 1. In other embodiments, the pH of the composite materials is between about 5 and 6, between about 6 and 7, between about 7 and 8 or between 8 and 9 or between 9 and 10. In still other embodiments, the pH is high and the pH of the composite materials ranges is greater than 8, greater than 9, greater than 10, greater than 11, greater than 12, or even greater than 13.

The silicon-carbon composite material may comprise varying amounts of carbon, oxygen, hydrogen and nitrogen as measured by gas chromatography CHNO analysis. In one embodiment, the carbon content of the composite is greater than 98 wt. % or even greater than 99.9 wt % as measured by CHNO analysis. In another embodiment, the carbon content of the silicon-carbon composite ranges from about 10-90%, for example 20-80%, for example 30-70%, for example 40-60%.

In some embodiments, silicon-carbon composite material comprises a nitrogen content ranging from 0-90%, example 0.1-1%, for example 1-3%, for example 1-5%, for example 1-10%, for example 10-20%, for example 20-30%, for example 30-90%.

In some embodiments, the oxygen content ranges from 0-90%, example 0.1-1%, for example 1-3%, for example 1-5%, for example 1-10%, for example 10-20%, for example 20-30%, for example 30-90%.

The silicon-carbon composite material may also incorporate an electrochemical modifier selected to optimize the electrochemical performance of the non-modified composite. The electrochemical modifier may be incorporated within the pore structure and/or on the surface of the porous carbon scaffold, within the embedded silicon, or within the final layer of carbon, or conductive polymer, coating, or incorporated in any number of other ways. For example, in some embodiments, the composite materials comprise a coating of the electrochemical modifier (e.g., silicon or Al₂O₃) on the surface of the carbon materials. In some embodiments, the composite materials comprise greater than about 100 ppm of an electrochemical modifier. In certain embodiments, the electrochemical modifier is selected from iron, tin, silicon, nickel, aluminum and manganese.

In certain embodiments the electrochemical modifier comprises an element with the ability to lithiate from 3 to 0 V versus lithium metal (e.g. silicon, tin, sulfur). In other embodiments, the electrochemical modifier comprises metal oxides with the ability to lithiate from 3 to 0 V versus lithium metal (e.g. iron oxide, molybdenum oxide, titanium oxide). In still other embodiments, the electrochemical modifier comprises elements which do not lithiate from 3 to 0 V versus lithium metal (e.g. aluminum, manganese, nickel, metal-phosphates). In yet other embodiments, the electrochemical modifier comprises a non-metal element (e.g. fluorine, nitrogen, hydrogen). In still other embodiments, the electrochemical modifier comprises any of the foregoing electrochemical modifiers or any combination thereof (e.g. tin-silicon, nickel-titanium oxide).

The electrochemical modifier may be provided in any number of forms. For example, in some embodiments the electrochemical modifier comprises a salt. In other embodiments, the electrochemical modifier comprises one or more elements in elemental form, for example elemental iron, tin, silicon, nickel or manganese. In other embodiments, the electrochemical modifier comprises one or more elements in oxidized form, for example iron oxides, tin oxides, silicon oxides, nickel oxides, aluminum oxides or manganese oxides.

The electrochemical properties of the composite material can be modified, at least in part, by the amount of the electrochemical modifier in the material, wherein the electrochemical modifier is an alloying material such as silicon, tin, indium, aluminum, germanium, gallium. Accordingly, in some embodiments, the composite material comprises at least 0.10%, at least 0.25%, at least 0.50%, at least 1.0%, at least 5.0%, at least 10%, at least 25%, at least 50%, at least 75%, at least 90%, at least 95%, at least 99% or at least 99.5% of the electrochemical modifier.

The particle size of the composite material may expand upon lithiation as compared to the non-lithiated state. For example, the expansion factor, defined as ratio of the average particle size of particles of composite material comprising a porous silicon material upon lithiation divided by the average particle size under non-lithiated conditions. As described in the art, this expansion factor can be relatively large for previously known, non-optimal silicon-containing materials, for example about 4× (corresponding to a 400% volume expansion upon lithiation). The current inventors have discovered composite materials comprising a porous silicon material that can exhibit a lower extent of expansion, for example, the expansion factor can vary from 3.5 to 4, from 3.0 to 3.5, from 2.5 to 3.0, from 2.0 to 2.5, from 1.5 to 2.0, from 1.0 to 1.5.

It is envisioned that composite materials in certain embodiments will comprise a fraction of trapped pore volume, namely, void volume non-accessible to nitrogen gas as probed by nitrogen gas sorption measurement. Without being bound by theory, this trapped pore volume is important in that it provides volume into which silicon can expand upon lithiation.

In certain embodiments, the ratio of trapped void volume to the silicon volume comprising the composite particle is between 0.1:1 and 10:1. For example, the ratio of trapped void volume to the silicon volume comprising the composite particle is between 1:1 and 5:1, or 5:1 to 10:1. In embodiments, the ratio of ratio trapped void volume to the silicon volume comprising the composite particle is between 2:1 and 5:1, or about 3:1, in order to efficiently accommodate the maximum extent of expansion of silicon upon lithiation.

In some embodiments, the composite particles have an average sphericity (as defined herein) of at least 0.5, or at least 0.55. In other embodiments, the average sphericity is at least 0.65, or at least 0.7, or at least 0.75, or at least 0.8.

It is possible to obtain highly accurate two-dimensional projections of micron scale particles by scanning electron microscopy (SEM) or by dynamic image analysis, in which a digital camera is used to record the shadow projected by a particle. The term “sphericity” as used herein is understood as the ratio of the area of the particle projection (obtained from such imaging techniques) to the area of a circle, wherein the particle projection and circle have identical circumference. Thus, for an individual particle, the sphericity S may be defined as:

$$S = \frac{4 * π * {A}_{m}}{{( {C}_{m} )}^{2}}$$

wherein Aₘ is the measured area of the particle projection and Cₘ is the measured circumference of the particle projection. The average sphericity Sₐᵥ of a population of particles as used herein is defined as:

$${S}_{av} = \frac{1}{n} {\sum }_{i = 1}^{n} [ \frac{4 * π * {A}_{m}}{{( {C}_{m} )}^{2}} ]$$

wherein n represents the number of particles in the population. The average sphericity for a population of particles is preferably calculated from the two-dimensional projections of at least 50 particles.

In certain embodiments, the electrochemical performance of the composite disclosed herein is tested in a half-cell; alternatively the performance of the composite with extremely durable intercalation of lithium disclosed herein is tested in a full cell, for example a full cell coin cell, a full cell pouch cell, a prismatic cell, or other battery configurations known in the art. The anode composition comprising the composite with extremely durable intercalation of lithium disclosed herein can further comprise various species, as known in the art. Additional formulation components include, but are not limited to, conductive additives, such as conductive carbons such as Super C45, Super P, Ketjenblack carbons, and the like, conductive polymers and the like, binders such as styrene-butadiene rubber sodium carboxymethylcellulose (SBR-Na-CMC), polyvinylidene difluoride (PVDF), polyimide (PI), polyacrylic acid (PAA) and the like, and combinations thereof. In certain embodiments, the binder can comprise a lithium ion as counter ion.

Other species comprising the electrode are known in the art. The % of active material in the electrode by weight can vary, for example between 1 and 5%, for example between 5 and 15%, for example between 15 and 25%, for example between 25 and 35%, for example between 35 and 45%, for example between 45 and 55%, for example between 55 and 65%, for example between 65 and 75%, for example between 75 and 85%, for example between 85 and 95%. In some embodiments, the active material comprises between 80 and 95% of the electrode. In certain embodiment, the amount of conductive additive in the electrode can vary, for example between 1 and 5%, between 5 and 15%, for example between 15 and 25%, for example between 25 and 35%. In some embodiments, the amount of conductive additive in the electrode is between 5 and 25%. In certain embodiments, the amount of binder can vary, for example between 1 and 5%, between 5 and 15%, for example between 15 and 25%, for example between 25 and 35%. In certain embodiments, the amount of conductive additive in the electrode is between 5 and 25%.

The silicon-carbon composite material may be prelithiated, as known in the art. In certain embodiments, the prelithiation is achieved electrochemically, for example in a half cell, prior to assembling the lithiated anode comprising the porous silicon material into a full cell lithium ion battery. In certain embodiments, prelithiation is accomplished by doping the cathode with a lithium-containing compound, for example a lithium containing salt. Examples of suitable lithium salts in this context include, but are not limited to, dilithium tetrabromonickelate(II), dilithium tetrachlorocuprate(II), lithium azide, lithium benzoate, lithium bromide, lithium carbonate, lithium chloride, lithium cyclohexanebutyrate, lithium fluoride, lithium formate, lithium hexafluoro arsenate(V), lithium hexafluorophosphate, lithium hydroxide, lithium iodate, lithium iodide, lithium metaborate, lithium perchlorate, lithium phosphate, lithium sulfate, lithium tetraborate, lithium tetrachloroaluminate, lithium tetrafluoroborate, lithium thiocyanate, lithium trifluoromethanesulfonate, lithium trifluoromethanesulfonate, and combinations thereof.

The anode comprising the silicon-carbon composite material can be paired with various cathode materials to result in a full cell lithium ion battery. Examples of suitable cathode materials are known in the art. Examples of such cathode materials include, but are not limited to LiCoO₂ (LCO), LiNi_{0.8}Co_{0.15}Al_{0.05}O₂ (NCA), LiNi_{1/3}Co_{1/3}Mn_{1/3}O₂ (NMC), LiMn₂O₄ and variants (LMO), and LiFePO₄ (LFP).

For the full cell lithium ion battery comprising an anode further comprising the silicon-carbon composite material, pairing of cathode to anode can be varied. For example, the ratio of cathode-to-anode capacity can vary from 0.7 to 1.3. In certain embodiments, the ratio of cathode-to-anode capacity can vary from 0.7 to 1.0, for example from 0.8 to 1.0, for example from 0.85 to 1.0, for example from 0.9 to 1.0, for example from 0.95 to 1.0. In other embodiments, the ratio of cathode-to-anode capacity can vary from 1.0 to 1.3, for example from 1.0 to 1.2, for example from 1.0 to 1.15, for example from 1.0 to 1.1, for example from 1.0 to 1.05. In yet other embodiments, the ratio of cathode-to-anode capacity can vary from 0.8 to 1.2, for example from 0.9 to 1.1, for example from 0.95 to 1.05.

For the full cell lithium ion battery comprising an anode further comprising the silicon-carbon composite material, the voltage window for charging and discharging can be varied. In this regard, the voltage window can be varied as known in the art, depending on various properties of the lithium ion battery. For instance, the choice of cathode plays a role in the voltage window chosen, as known in the art. Examples of voltage windows vary, for example, in terms of potential versus Li/Li+, from 2.0 V to 5.0 V, for example from 2.5 V to 4.5V, for example from 2.5V to 4.2V.

For the full cell lithium ion battery comprising an anode further comprising the silicon-carbon composite material, the strategy for conditioning the cell can be varied as known in the art. For example, the conditioning can be accomplished by one or more charge and discharge cycles at various rate(s), for example at rates slower than the desired cycling rate. As known in the art, the conditioning process may also include a step to unseal the lithium ion battery, evacuate any gases generated within during the conditioning process, followed by resealing the lithium ion battery.

For the full cell lithium ion battery comprising an anode further comprising the silicon-carbon composite material, the cycling rate can be varied as known in the art, for example, the rate can between C/20 and 20C, for example between C10 to 10C, for example between C/5 and 5C. In certain embodiments, the cycling rate is C/10. In certain embodiments, the cycling rate is C/5. In certain embodiments, the cycling rate is C/2. In certain embodiments, the cycling rate is 1C. In certain embodiments, the cycling rate is 1C, with periodic reductions in the rate to a slower rate, for example cycling at 1C with a C/10 rate employed every 20th cycle. In certain embodiments, the cycling rate is 2C. In certain embodiments, the cycling rate is 4C. In certain embodiments, the cycling rate is 5C. In certain embodiments, the cycling rate is 10C. In certain embodiments, the cycling rate is 20C.

The first cycle efficiency of the composite with extremely durable intercalation of lithium disclosed herein be determined by comparing the lithium inserted into the anode during the first cycle to the lithium extracted from the anode on the first cycle, prior prelithiation modification. When the insertion and extraction are equal, the efficiency is 100%. As known in the art, the anode material can be tested in a half-cell, where the counter electrode is lithium metal, the electrolyte is a 1M LiPF₆ 1:1 ethylene carbonate:diethylcarbonate (EC:DEC), using a commercial polypropylene separator. In certain embodiments, the electrolyte can comprise various additives known to provide improved performance, such as fluoroethylene carbonate (FEC) or other related fluorinated carbonate compounds, or ester co-solvents such as methyl butyrate, vinylene carbonate, and other electrolyte additives known to improve electrochemical performance of silicon-comprising anode materials.

Coulombic efficiency can be averaged, for example averaged over cycles 7 to cycle 25 when tested in a half cell. Coulombic efficiency can be averaged, for example averaged over cycles 7 to cycle 20 when tested in a half cell. In certain embodiments, the average efficiency of the composite with extremely durable intercalation of lithium is greater than 0.9, or 90%. In certain embodiments, the average efficiency is greater than 0.95, or 95%. In certain other embodiments, the average efficiency is 0.99 or greater, for example 0.991 or greater, for example 0.992 or greater, for example 0.993 or greater, for example 0.994 or greater, for example 0.995 or greater, for example 0.996 or greater, for example 0.997 or greater, for example 0.998 or greater, for example 0.999 or greater, for example 0.9991 or greater, for example 0.9992 or greater, for example 0.9993 or greater, for example 0.9994 or greater, for example 0.9995 or greater, for example 0.9996 or greater, for example 0.9997 or greater, for example 0.9998 or greater, for example 0.9999 or greater.

In still other embodiments the present disclosure provides a composite material exhibiting extremely durable intercalation of lithium, wherein when the composite material is incorporated into an electrode of a lithium-based energy storage device the composite material has a volumetric capacity at least 10% greater than when the lithium based energy storage device comprises a graphite electrode. In some embodiments, the lithium based energy storage device is a lithium ion battery. In other embodiments, the composite material has a volumetric capacity in a lithium-based energy storage device that is at least 5% greater, at least 10% greater, at least 15% greater than the volumetric capacity of the same electrical energy storage device having a graphite electrode. In still other embodiments, the composite material has a volumetric capacity in a lithium based energy storage device that is at least 20% greater, at least 30% greater, at least 40% greater, at least 50% greater, at least 200% greater, at least 100% greater, at least 150% greater, or at least 200% greater than the volumetric capacity of the same electrical energy storage device having a graphite electrode.

The composite material may be prelithiated, as known in the art. These lithium atoms may or may not be able to be separated from the carbon. The number of lithium atoms to 6 carbon atoms (#Li) can be calculated by techniques known to those familiar with the art:

$$\#Li = Q \times 3.6 \times MM / ( C \% \times F )$$

wherein Q is the lithium extraction capacity measured in mAh/g between the voltages of 5 mV and 2.0V versus lithium metal, MM is 72 or the molecular mass of 6 carbons, F is Faraday's constant of 96500, C % is the mass percent carbon present in the structure as measured by CHNO or XPS.

The composite material can be characterized by the ratio of lithium atoms to carbon atoms (Li:C) which may vary between about 0:6 and 2:6. In some embodiments the Li:C ratio is between about 0.05:6 and about 1.9:6. In other embodiments the maximum Li:C ratio wherein the lithium is in ionic and not metallic form is 2.2:6. In certain other embodiments, the Li:C ratio ranges from about 1.2:6 to about 2:6, from about 1.3:6 to about 1.9:6, from about 1.4:6 to about 1.9:6, from about 1.6:6 to about 1.8:6 or from about 1.7:6 to about 1.8:6. In other embodiments, the Li:C ratio is greater than 1:6, greater than 1.2:6, greater than 1.4:6, greater than 1.6:6 or even greater than 1.8:6. In even other embodiments, the Li:C ratio is about 1.4:6, about 1.5:6, about 1.6:6, about 1.6:6, about 1.7:6, about 1.8:6 or about 2:6. In a specific embodiment the Li:C ratio is about 1.78:6.

In certain other embodiments, the composite material comprises an Li:C ratio ranging from about 1:6 to about 2.5:6, from about 1.4:6 to about 2.2:6 or from about 1.4:6 to about 2:6. In still other embodiments, the composite materials may not necessarily include lithium, but instead have a lithium uptake capacity (i.e., the capability to uptake a certain quantity of lithium, for example upon cycling the material between two voltage conditions (in the case of a lithium ion half cell, an exemplary voltage window lies between 0 and 3 V, for example between 0.005 and 2.7 V, for example between 0.005 and 1 V, for example between 0.005 and 0.8 V). While not wishing to be bound by theory, it is believed the lithium uptake capacity of the composite materials contributes to their superior performance in lithium based energy storage devices. The lithium uptake capacity is expressed as a ratio of the atoms of lithium taken up by the composite. In certain other embodiments, the composite material exhibiting extremely durable intercalation of lithium comprise a lithium uptake capacity ranging from about 1:6 to about 2.5:6, from about 1.4:6 to about 2.2:6 or from about 1.4:6 to about 2:6.

In certain other embodiments, the lithium uptake capacity ranges from about 1.2:6 to about 2:6, from about 1.3:6 to about 1.9:6, from about 1.4:6 to about 1.9:6, from about 1.6:6 to about 1.8:6 or from about 1.7:6 to about 1.8:6. In other embodiments, the lithium uptake capacity is greater than 1:6, greater than 1.2:6, greater than 1.4:6, greater than 1.6:6 or even greater than 1.8:6. In even other embodiments, the Li:C ratio is about 1.4:6, about 1.5:6, about 1.6:6, about 1.6:6, about 1.7:6, about 1.8:6 or about 2:6. In a specific embodiment the Li:C ratio is about 1.78:6.

### EXAMPLES

### Example 1

### Production of Silicon-Carbon Composite Material by CVI.

The properties of the carbon scaffold (Carbon Scaffold 1) employed for producing the silicon-carbon composite is presented in Table 4. Employing Carbon Scaffold 1, the silicon-carbon composite (Silicon-Carbon Composite 1) was produced by CVI as follows. A mass of 0.2 grams of amorphous porous carbon was placed into a 2 in.×2 in. ceramic crucible then positioned in the center of a horizontal tube furnace. The furnace was sealed and continuously purged with nitrogen gas at 500 cubic centimeters per minute (ccm). The furnace temperature was increased at 20° C./min to 450° C. peak temperature where it was allowed to equilibrate for 30 minutes. At this point, the nitrogen gas is shutoff and then silane and hydrogen gas are introduced at flow rates of 50 ccm and 450 ccm, respectively for a total dwell time of 30 minutes. After the dwell period, silane and hydrogen were shutoff and nitrogen was again introduced to the furnace to purge the internal atmosphere. Simultaneously the furnace heat is shutoff and allowed to cool to ambient temperature. The completed Si—C material is subsequently removed from the furnace.

TABLE 4
Description of carbon scaffold employed for Example 1.

| Carbon | Surface | Pore | % | % | % |
|---|---|---|---|---|---|
| Scaffold | Area | Volume | Micro- | Meso- | Macro- |
| # | (m2/g) | (cm3/g) | pores | pores | pores |
| 1 | 1710 | 0.762 | 93.1 | 6.8 | 0.1 |

### Example 2

### Analysis of Various Silicon-Composite Materials.

A variety of carbon scaffold materials were employed, and the carbon scaffold materials were characterized by nitrogen sorption gas analysis to determine specific surface area, total pore volume, and fraction of pore volume comprising micropores, mesopores, and macropores. The characterization data for the carbon scaffold materials is presented in Table 5, namely the data for carbon scaffold surface area, pore volume, and pore volume distribution (% micropores, % mesopores, and % macropores), all as determined by nitrogen sorption analysis.

TABLE 5
Properties of various carbon scaffold materials.

| Carbon | Surface | Pore | % | % | % |
|---|---|---|---|---|---|
| Scaffold | Area | Volume | Micro- | Meso- | Macro- |
| # | (m2/g) | (cm3/g) | pores | pores | pores |
| 1 | 1710 | 0.762 | 93.1 | 6.8 | 0.1 |
| 2 | 1744 | 0.72 | 97.2 | 2.7 | 0.1 |
| 3 | 1581 | 0.832 | 69.1 | 30.9 | 0.1 |
| 4 | 1710 | 0.817 | 80.1 | 19.9 | 0 |
| 5 | 1835 | 0.9 | 82.2 | 17.8 | 0 |
| 6 | 1475 | 1.06 | 52.4 | 47.6 | 0 |
| 7 | 453 | 0.5 | 3.9 | 91.1 | 5.1 |
| 8 | 787 | 2.284 | 0 | 59.1 | 40.9 |
| 9 | 1713 | 0.76 | 91 | 9 | 0 |

The carbon scaffold samples as described in Table 5 were employed to produce a variety of silicon-carbon composite materials employing the CVI methodology in a static bed configuration as generally described in Example 1. These silicon-carbon samples were produced employing a range of process conditions: silane concentration 1.25% to 100%, diluent gas nitrogen or hydrogen, carbon scaffold starting mass 0.2 g to 700 g.

The surface area for the silicon-carbon composites was determined. The silicon-carbon composites were also analyzed by TGA to determine silicon content and the Z. Silicon-carbon composite materials were also tested in half-cell coin cells. The anode for the half-cell coin cell can comprise 60-90% silicon-carbon composite, 5-20% Na-CMC (as binder) and 5-20% Super C45 (as conductivity enhancer), and the electrolyte can comprise 2:1 ethylene carbonate:diethylene carbonate, 1 M LiPF6 and 10% fluoroethylene carbonate. The half-cell coin cells can be cycled at 25° C. at a rate of C/5 for 5 cycles and then cycled thereafter at C/10 rate. The voltage can be cycled between 0 V and 0.8 V, alternatively, the voltage can be cycled between 0 V and 1.5 V. From the half-cell coin cell data, the maximum capacity can be measured, as well as the average Coulombic efficiency (CE) over the range of cycles from cycle 7 to cycle 20. Physicochemical and electrochemical properties for various silicon-carbon composite materials are presented in Table 6.

TABLE 6
Properties of various silicon-carbon materials.

| Silicon- | | | | | | |
|---|---|---|---|---|---|---|
| Carbon | Carbon | Surface | Si | | Max | Average |
| Composite | Scaffold | Area | content | | Capacity | CE |
| # | # | (m2/g) | (%) | Z | (mAh/g) | (7-20) |
| 1 | 1 | 7 | 45.0 | 0.2 | 1433 | 0.9981 |
| 2 | 1 | 7 | 45.4 | 0.6 | 1545 | 0.9980 |
| 3 | 1 | 6 | 45.8 | 0.6 | 1510 | 0.9975 |
| 4 | 2 | 3.06 | 50.1 | 1.0 | 1665 | 0.9969 |
| 5 | 2 | 1.96 | 51.3 | 2.0 | 1662 | 0.9974 |
| 6 | 3 | 140 | 43.1 | 3.2 | 832 | 0.9941 |
| 7 | 2 | 1.61 | 48.7 | 2.8 | 1574 | 0.9977 |
| 8 | 2 | 2 | 48.5 | 3.0 | 1543 | 0.9972 |
| 9 | 1 | 8 | 46.3 | 0.2 | 1373 | 0.9976 |
| 10 | 4 | 44 | 51.2 | 6.2 | 1614 | 0.9975 |
| 11 | 5 | 94 | 48.9 | 6.2 | 1455 | 0.9969 |
| 12 | 6 | 61 | 52.1 | 10.6 | 2011 | 0.9869 |
| 13 | 7 | 68.5 | 34.6 | 17.2 | 1006 | 0.9909 |
| 14 | 8 | 20 | 74 | 33.5 | 2463 | 0.9717 |
| 15 | 8 | 149 | 57.7 | 34.5 | 1892 | 0.9766 |
| 16 | 8 | 61.7 | 68.9 | 38.7 | 2213 | 0.9757 |
| 17 | 9 | 11 | 46.1 | 0.8 | 1675 | 0.9990 |
| 18 | 9 | 11 | 46.7 | 2.0 | 1739 | 0.9985 |
| 19 | 9 | 15.1 | 46.8 | 1.7 | 1503 | 0.9980 |
| 20 | 9 | 4.1 | 47.9 | 4.2 | 1790 | 0.9953 |
| 21a | 9 | 5 | 48.1 | 4.6 | 1861 | 0.9962 |

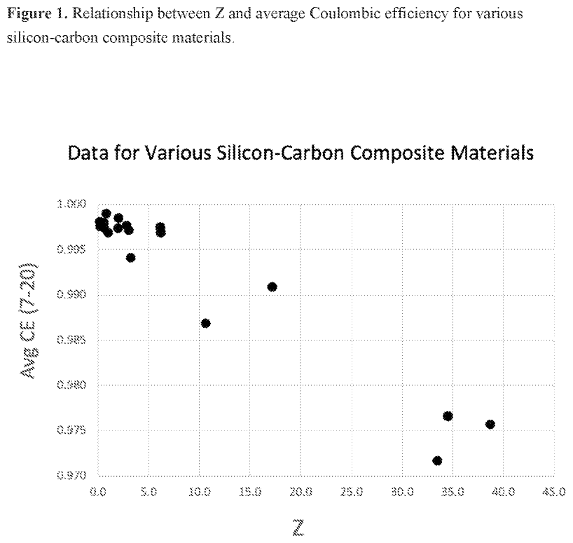

A plot of the average Coulombic efficiency as a function of the Z is presented in FIG. 1. As can be seen, there was dramatic increase in the average Coulombic efficiency for silicon-carbon samples with low Z. In particular, all silicon-carbon samples with Z below 10.0 exhibited average Coulombic efficiency≥0.9941, and all silicon-carbon samples with Z above 10 (Silicon-Carbon Composite Sample 12 through Silicon-Carbon Composite Sample 16) were observed to have average Coulombic efficiency≤0.9909. Without being bound by theory, higher Coulombic efficiency for the silicon-carbon samples with Z<10 provides for superior cycling stability in full cell lithium ion batteries. Further inspection of Table reveals the surprising and unexpected finding that the combination of silicon-carbon composite samples with Z<10 and also comprising carbon scaffold comprising ≥70 microporosity provides for average Coulombic efficiency≥0.9950.

Therefore, in a preferred embodiment, the silicon-carbon composite material comprises a Z less than 10, for example less Z less than 5, for example less Z less than 3, for example less Z less than 2, for example less Z less than 1, for example less Z less than 0.5, for example less Z less than 0.1, or Z of zero.

In certain preferred embodiments, the silicon-carbon composite material comprises a Z less than 10 and a carbon scaffold with >70% microporosity, for example Z less than 10 and >80% microporosity, for example Z less than 10 and >90% microporosity, for example Z less than 10 and >95% microporosity, for example Z less than 5 and >70% microporosity, for example Z less than 5 and >80% microporosity, for example Z less than 5 and >90% microporosity, for example Z less than 5 and >95% microporosity, for example Z less than 3 and >70% microporosity, for example Z less than 3 and >80% microporosity, for example Z less than 3 and >90% microporosity, for example Z less than 3 and >95% microporosity, for example Z less than 2 and >70% microporosity, for example Z less than 2 and >80% microporosity, for example Z less than 2 and >90% microporosity, for example Z less than 2 and >95% microporosity, for example Z less than 1 and >70% microporosity, for example Z less than 1 and >80% microporosity, for example Z less than 1 and >90% microporosity, for example Z less than 1 and >95% microporosity, for example Z less than 0.5 and >70% microporosity, for example Z less than 0.5 and >80% microporosity, for example Z less than 0.5 and >90% microporosity, for example Z less than 0.5 and >95% microporosity, for example Z less than 0.1 and >70% microporosity, for example Z less than 0.1 and >80% microporosity, for example Z less than 0.1 and >90% microporosity, for example Z less than 0.1 and >95% microporosity, for example Z of zero and >70% microporosity, for example Z of zero and >80% microporosity, for example Z of zero and >90% microporosity, for example Z of zero and >95% microporosity.

In certain preferred embodiments, the silicon-carbon composite material comprises a Z less than 10 and a carbon scaffold with >70% microporosity, and wherein the silicon-carbon composite also comprises 15%-85% silicon, and surface area less than 100 m2/g, for example Z less than 10 and >70% microporosity, and wherein the silicon-carbon composite also comprises 15%-85% silicon, and surface area less than 50 m2/g, for example Z less than 10 and >70% microporosity, and wherein the silicon-carbon composite also comprises 15%-85% silicon, and surface area less than 30 m2/g, for example Z less than 10 and >70% microporosity, and wherein the silicon-carbon composite also comprises 15%-85% silicon, and surface area less than 10 m2/g, for example Z less than 10 and >70% microporosity, and wherein the silicon-carbon composite also comprises 15%-85% silicon, and surface area less than 5 m2/g, for example Z less than 10 and >80% microporosity, and wherein the silicon-carbon composite also comprises 15%-85% silicon, and surface area less than 50 m2/g, for example Z less than 10 and >80% microporosity, and wherein the silicon-carbon composite also comprises 15%-85% silicon, and surface area less than 30 m2/g, for example Z less than 10 and >80% microporosity, and wherein the silicon-carbon composite also comprises 15%-85% silicon, and surface area less than 10 m2/g, for example Z less than 10 and >80% microporosity, and wherein the silicon-carbon composite also comprises 15%-85% silicon, and surface area less than 5 m2/g, for example Z less than 10 and >90% microporosity, and wherein the silicon-carbon composite also comprises 15%-85% silicon, and surface area less than 50 m2/g, for example Z less than 10 and >90% microporosity, and wherein the silicon-carbon composite also comprises 15%-85% silicon, and surface area less than 30 m2/g, for example Z less than 10 and >90% microporosity, and wherein the silicon-carbon composite also comprises 15%-85% silicon, and surface area less than 10 m2/g, for example Z less than 10 and >90% microporosity, and wherein the silicon-carbon composite also comprises 15%-85% silicon, and surface area less than 5 m2/g, for example Z less than 10 and >95% microporosity, and wherein the silicon-carbon composite also comprises 15%-85% silicon, and surface area less than 50 m2/g, for example Z less than 10 and >95% microporosity, and wherein the silicon-carbon composite also comprises 15%-85% silicon, and surface area less than 30 m2/g, for example Z less than 10 and >95% microporosity, and wherein the silicon-carbon composite also comprises 15%-85% silicon, and surface area less than 10 m2/g, for example Z less than 10 and >95% microporosity, and wherein the silicon-carbon composite also comprises 15%-85% silicon, and surface area less than 5 m2/g.

In certain preferred embodiments, the silicon-carbon composite material comprises a Z less than 10 and a carbon scaffold with >70% microporosity, and wherein the silicon-carbon composite also comprises 30%-60% silicon, and surface area less than 100 m2/g, for example Z less than 10 and >70% microporosity, and wherein the silicon-carbon composite also comprises 30%-60% silicon, and surface area less than 50 m2/g, for example Z less than 10 and >70% microporosity, and wherein the silicon-carbon composite also comprises 30%-60% silicon, and surface area less than 30 m2/g, for example Z less than 10 and >70% microporosity, and wherein the silicon-carbon composite also comprises 30%-60% silicon, and surface area less than 10 m2/g, for example Z less than 10 and >70% microporosity, and wherein the silicon-carbon composite also comprises 30%-60% silicon, and surface area less than 5 m2/g, for example Z less than 10 and >80% microporosity, and wherein the silicon-carbon composite also comprises 30%-60% silicon, and surface area less than 50 m2/g, for example Z less than 10 and >80% microporosity, and wherein the silicon-carbon composite also comprises 30%-60% silicon, and surface area less than 30 m2/g, for example Z less than 10 and >80% microporosity, and wherein the silicon-carbon composite also comprises 30%-60% silicon, and surface area less than 10 m2/g, for example Z less than 10 and >80% microporosity, and wherein the silicon-carbon composite also comprises 30%-60% silicon, and surface area less than 5 m2/g, for example Z less than 10 and >90% microporosity, and wherein the silicon-carbon composite also comprises 30%-60% silicon, and surface area less than 50 m2/g, for example Z less than 10 and >90% microporosity, and wherein the silicon-carbon composite also comprises 30%-60% silicon, and surface area less than 30 m2/g, for example Z less than 10 and >90% microporosity, and wherein the silicon-carbon composite also comprises 30%-60% silicon, and surface area less than 10 m2/g, for example Z less than 10 and >90% microporosity, and wherein the silicon-carbon composite also comprises 30%-60% silicon, and surface area less than 5 m2/g, for example Z less than 10 and >95% microporosity, and wherein the silicon-carbon composite also comprises 30%-60% silicon, and surface area less than 50 m2/g, for example Z less than 10 and >95% microporosity, and wherein the silicon-carbon composite also comprises 30%-60% silicon, and surface area less than 30 m2/g, for example Z less than 10 and >95% microporosity, and wherein the silicon-carbon composite also comprises 30%-60% silicon, and surface area less than 10 m2/g, for example Z less than 10 and >95% microporosity, and wherein the silicon-carbon composite also comprises 30%-60% silicon, and surface area less than 5 m2/g.

In certain preferred embodiments, the silicon-carbon composite material comprises a Z less than 10 and a carbon scaffold with >80% microporosity, and wherein the silicon-carbon composite also comprises 30%-60% silicon, surface area less than 30 m2/g, and average Coulombic efficiency≥0.9969. For example, the silicon-carbon composite material comprises a Z less than 10 and a carbon scaffold with >80% microporosity, and wherein the silicon-carbon composite also comprises 30%-60% silicon, surface area less than 30 m2/g, and average Coulombic efficiency≥0.9970. For example, the silicon-carbon composite material comprises a Z less than 10 and a carbon scaffold with >80% microporosity, and wherein the silicon-carbon composite also comprises 30%-60% silicon, surface area less than 30 m2/g, and average Coulombic efficiency≥0.9975. For example, the silicon-carbon composite material comprises a Z less than 10 and a carbon scaffold with >80% microporosity, and wherein the silicon-carbon composite also comprises 30%-60% silicon, surface area less than 30 m2/g, and average Coulombic efficiency≥0.9980. For example, the silicon-carbon composite material comprises a Z less than 10 and a carbon scaffold with >80% microporosity, and wherein the silicon-carbon composite also comprises 30%-60% silicon, surface area less than 30 m2/g, and average Coulombic efficiency≥0.9985. For example, the silicon-carbon composite material comprises a Z less than 10 and a carbon scaffold with >80% microporosity, and wherein the silicon-carbon composite also comprises 30%-60% silicon, surface area less than 30 m2/g, and average Coulombic efficiency≥0.9990. For example, the silicon-carbon composite material comprises a Z less than 10 and a carbon scaffold with >80% microporosity, and wherein the silicon-carbon composite also comprises 30%-60% silicon, surface area less than 30 m2/g, and average Coulombic efficiency≥0.9995. For example, the silicon-carbon composite material comprises a Z less than 10 and a carbon scaffold with >80% microporosity, and wherein the silicon-carbon composite also comprises 30%-60% silicon, surface area less than 30 m2/g, and average Coulombic efficiency≥0.9999.

### Example 3

### DV/DQ for Various Silicon-Composite Materials.

Differential capacity curve (dQ/dV vs Voltage) is often used as a non-destructive tool to understand the phase transition as a function of voltage in lithium battery electrodes (M. N. Obrovac et al. Structural Changes in Silicon Anodes during Lithium Insertion/Extraction, Electrochemical and Solid-State Letters, 7 (5) A93-A96 (2004); Ogata, K. et al. Revealing lithium-silicide phase transformations in nano-structured silicon-based lithium ion batteries via in situ NMR spectroscopy. Nat. Commun. 5:3217). Differential capacity plots presented here is calculated from the data obtained using galvanostatic cycling at 0.1C rate between 5 mV to 0.8V in a half-cell coin cell at 25° C. Typical differential capacity curve for a silicon-based material in a half-cell vs lithium can be found in many literature references (Loveridge, M. J. et al. Towards High Capacity Li-Ion Batteries Based on Silicon-Graphene Composite Anodes and Sub-micron V-doped LiFePO4 Cathodes. Sci. Rep. 6, 37787; doi: 10.1038/srep37787 (2016); M. N. Obrovac et al. Li₁₅Si₄Formation in Silicon Thin Film Negative Electrodes, Journal of The Electrochemical Society, 163 (2) A255-A261 (2016); Q. Pan et al. Improved electrochemical performance of micro-sized SiO-based composite anode by prelithiation of stabilized lithium metal powder, Journal of Power Sources 347 (2017) 170-177). First cycle lithiation behavior is dependent on the crystallinity of the silicon and oxygen content among other factors.

After first cycle, previous amorphous silicon materials in the art exhibit two specific phase transition peaks in the dQ/dV vs V plot for lithiation, and correspondingly two specific phase transition peaks in the dQ/dV vs V plot for delithiation. For lithiation, one peak corresponding to lithium-poor Li—Si alloy phase occurs between 0.2-0.4 V and another peak corresponding to a lithium-rich Li—Si alloy phase occurs below 0.15 V. For delithiation, one delithiation peak corresponding to the extraction of lithium occurs below 0.4 V and another peak occurs between 0.4 V and 0.55 V. If the Li15Si4 phase is formed during lithiation, it is delithiated at ˜0.45V and appears as a very narrow sharp peak.

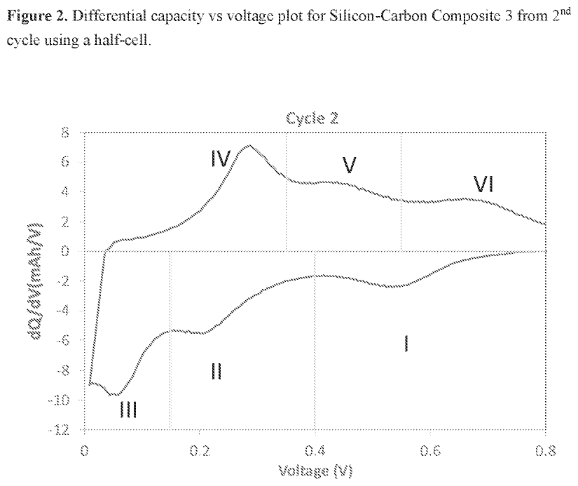

FIG. 2 depicts the dQ/dV vs Voltage curve for cycle 2 for the silicon-carbon composite material corresponding to Silicon-Carbon Composite 3 from Example 1. Silicon-Carbon Composite 3 comprises a Z of 0.6. For ease of identification, the plot is divided into regimes I, II, II, IV, V, and VI. Regimes I (0.8 V to 0.4 V), II (0.4 V to 0.15 V), III (0.15 V to 0 V) comprise the lithiation potentials and Regimes IV (0 V to 0.4 V), V (0.4 V to 0.55 V), VI (0.55 V to 0.8 V) comprise the delithiation potential. As described above, previous amorphous silicon-based materials in the art exhibit phase-transition peaks for two regimes (Regime II and Regime III) in the lithiation potential and two regimes (Regime IV and Regime V) in the delithiation potentials.

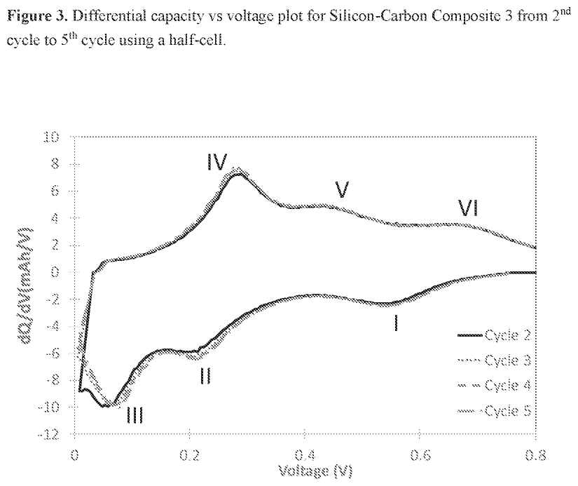

As can be seen in FIG. 2, the dQ/dV vs Voltage curve reveals surprising and unexpected result that Silicon-Carbon Composite 3, which comprises a Z of 0.6, comprises two additional peaks in the dQ/dV vs Voltage curve, namely Regime I in the lithiation potential and Regime VI in the delithiation potential. All 6 peaks are reversible and observed in the subsequent cycles as well, as shown in FIG. 3.

Without being bound by theory, such trimodal behavior for the dQ/dV vs V curve is novel, and likewise reflects a novel form of silicon.

Notably, the novel peaks observed in Regime I and Regime VI are more pronounced in certain scaffold matrixes and completely absent in other samples illustrating the prior art (silicon-carbon composite samples with Z>10, see explanation and table below).

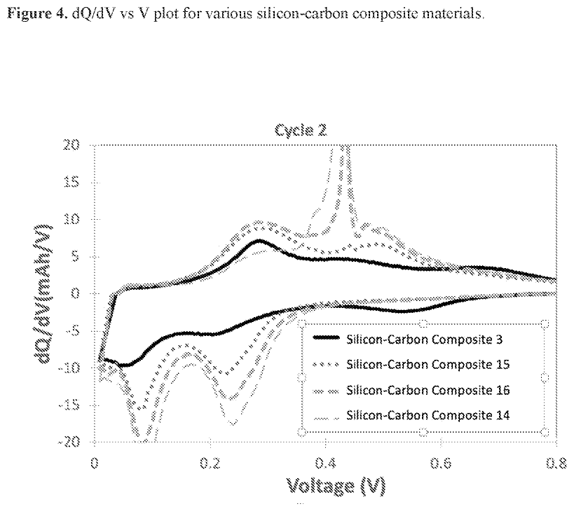

FIG. 4 presents the dQ/dV vs V curve for Silicon-Carbon Composite 3, wherein the novel peaks in Regime I and Regime VI are evident, in comparison to Silicon-Carbon Composite 15, Silicon-Carbon Composite 16, and Silicon-Carbon Composite 14, all three of which comprise Z>10 and whose dQ/dV vs V curves are devoid of the any peaks in Regime I and Regime VI.

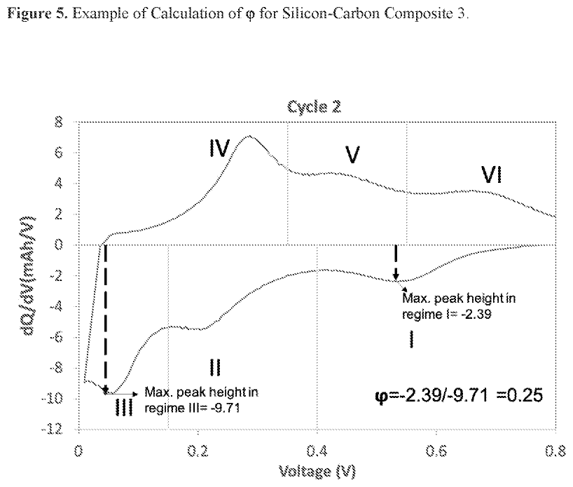

Without being bound by theory, these novel peaks observed in Regime I and Regime VI relate to the properties of the silicon impregnated into the porous carbon scaffold, i.e., related to the interactions between and among the properties of the porous carbon scaffold, the silicon impregnated into the porous carbon scaffold via CVI, and lithium. In order to provide a quantitative analysis, we herein define the parameter q (“phi”), which is calculated as the normalized peak I with respect to peak III as:

$$φ = ( Max peak height dQ / dV in Regime I ) / ( Max peak height dQ / dV in Regime III )$$

where dQ/dV is measured in a half-cell coin cell, and regime I is 0.8V-0.4V and Regime III is 0.15V-0V; the half-cell coin cell is produced as known in the art. If the Si—C sample shows peaks associated with graphite in regime III of the differential curve, it is omitted in favor of Li—Si related phase transition peaks for the calculation of D factor. For this example, the half-cell coin cell comprises an anode comprising 60-90% silicon-carbon composite, 5-20% SBR-Na-CMC, and 5-20% Super C45. An example for φ calculation is shown in FIG. 5 for Silicon-Carbon Composite 3. In this instance, the maximum peak height in the regime I is −2.39 and is found at voltage 0.53V. Similarly, maximum peak height in regime III is −9.71 at 0.04V. In this instance, φ can be calculated using the above formula, yielding φ=−2.39/−9.71=0.25. The value of φ was determined from the half-cell coin cell data for the various silicon-carbon composites presented in Example 2. These data are summarized in Table 7. Table 7 also includes data for the first cycle efficiency, as measured in half cell coin cells cycled from 5 mV to 0.8 V.

TABLE 7
Properties of various silicon-carbon carbon scaffold materials.

| Silicon- | | | | | | |
|---|---|---|---|---|---|---|
| Carbon | Surface | Si | | Average | | First |
| Composite | Area | content | | CE | | Cycle |
| # | (m2/g) | (%) | Z | (7-20) | φ | Efficiency |
| 1 | 7 | 45.0 | 0.2 | 0.9981 | 0.24 | 76.3 |
| 2 | 7 | 45.4 | 0.6 | 0.9980 | 0.24 | 76.8 |
| 3 | 6 | 45.8 | 0.6 | 0.9975 | 0.25 | 75.5 |
| 4 | 3.06 | 50.1 | 1.0 | 0.9969 | 0.18 | 80.9 |
| 5 | 1.96 | 51.3 | 2.0 | 0.9974 | 0.18 | 80.3 |
| 6 | 140 | 43.1 | 3.2 | 0.9941 | 0.13 | 52.3 |
| 7 | 1.61 | 48.7 | 2.8 | 0.9977 | 0.19 | 79.2 |
| 8 | 2 | 48.5 | 3.0 | 0.9972 | 0.19 | 78.3 |
| 9 | 8 | 46.3 | 0.2 | 0.9976 | 0.20 | 73.3 |
| 10 | 44 | 51.2 | 6.2 | 0.9975 | 0.13 | 78.1 |
| 11 | 94 | 48.9 | 6.2 | 0.9969 | 0.15 | 72.7 |
| 12 | 61 | 52.1 | 10.6 | 0.9869 | 0 | 80.2 |
| 13 | 68.5 | 34.6 | 17.2 | 0.9909 | 0 | 64 |
| 14 | 20 | 74 | 33.5 | 0.9717 | 0 | 85 |
| 15 | 149 | 57.7 | 34.5 | 0.9766 | 0 | 69 |
| 16 | 61.7 | 68.9 | 38.7 | 0.9757 | 0 | 79.3 |
| 17 | 11 | 46.1 | 0.8 | 0.9990 | 0.35 | 82.2 |
| 18 | 11 | 46.7 | 2.0 | 0.9985 | 0.34 | 82.5 (92.1*) |
| 19 | 15.1 | 46.8 | 1.7 | 0.9980 | 0.34 | 79.9 (90.3*) |
| 20 | 4.1 | 47.9 | 4.2 | 0.9953 | 0.33 | 83.3 (92.6*) |
| 21a | 5 | 48.1 | 4.6 | 0.9962 | 0.30 | 82.9 (92.2*) |

*These data for first cycle efficiency in parenthesis were measured for voltage window of 5 mV to 1.5 V.

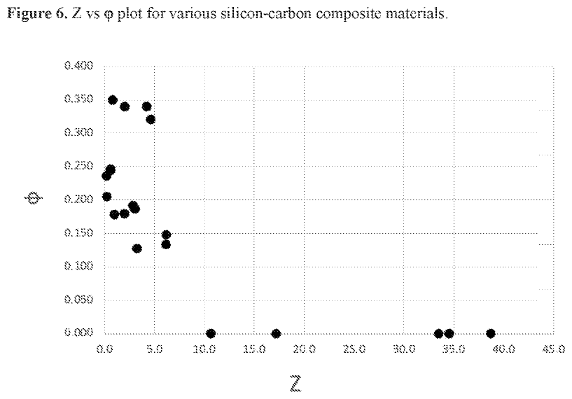

The data in Table 7 reveal an unexpected relationship between decreasing Z and increasing φ. All silicon-carbon composites with Z<10 had φ≥0.13, and all silicon-carbon composites with Z>10 had φ<0.13, indeed, all silicon-carbon composites with where Z>10 had φ=0. This relationship is also evidenced in FIG. 6. Without being bound by theory, silicon materials comprising φ≥0.10, for example φ≥0.13, for example φ≥0.15, for example φ≥0.20, for example φ≥0.25, for example φ≥0.30, correspond to a novel form of silicon. Alternatively, silicon materials comprising φ>0 correspond to a novel form of silicon. The silicon-carbon composite material comprising silicon comprising φ≥0.10, for example φ≥0.13, for example φ≥0.15, for example φ≥0.20, for example φ≥0.25, for example φ≥0.30, correspond to a novel silicon-carbon composite material. Alternatively, silicon-carbon composite materials comprising φ>0 corresponds to a novel silicon-carbon composite material.

In certain embodiments, the silicon-carbon composite comprises a φ≥0.1, φ≥0.11, φ≥0.12, φ=0.13, φ≥0.14, φ≥0.15, φ≥0.16, φ≥0.17, φ≥0.18, φ≥0.19, φ≥0.20, φ>0.24, φ≥0.24, φ≥0.25, φ≥0.30 or φ≥0.35. In some embodiments, φ>0. In some embodiments, φ≥0.001, φ≥0.01, φ≥0.02, φ≥0.05, φ≥0.1, φ≥0.11, or φ≥0.12.

In certain embodiments, the silicon-carbon composite material comprises a Z less than 10 and a carbon scaffold with >70% microporosity, and wherein the silicon-carbon composite also comprises 30%-60% silicon, and surface area less than 100 m2/g, and φ≥0.1, for example Z less than 10 and >70% microporosity, and wherein the silicon-carbon composite also comprises 30%-60% silicon, and surface area less than 50 m2/g, and φ≥0.1, for example Z less than 10 and >70% microporosity, and wherein the silicon-carbon composite also comprises 30%-60% silicon, and surface area less than 30 m2/g, and φ≥0.1, for example Z less than 10 and >70% microporosity, and wherein the silicon-carbon composite also comprises 30%-60% silicon, and surface area less than 10 m2/g, and φ≥0.1, for example Z less than 10 and >70% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >70% microporosity, and wherein the silicon-carbon composite also comprises 40%-60% silicon, and surface area less than 100 m2/g, and φ≥0.1, for example Z less than 10 and >70% microporosity, and wherein the silicon-carbon composite also comprises 40%-60% silicon, and surface area less than 50 m2/g, and φ≥0.1, for example Z less than 10 and >70% microporosity, and wherein the silicon-carbon composite also comprises 40%-60% silicon, and surface area less than 30 m2/g, and φ≥0.1, for example Z less than 10 and >70% microporosity, and wherein the silicon-carbon composite also comprises 40%-60% silicon, and surface area less than 10 m2/g, and φ≥0.1, for example Z less than 10 and >70% microporosity, and wherein the silicon-carbon composite also comprises 40%-60% silicon, and surface area less than 5 m2/g, and φ≥0.1.

In certain embodiments, the silicon-carbon composite material comprises a Z less than 10 and a carbon scaffold with >70% microporosity, and wherein the silicon-carbon composite also comprises 30%-60% silicon, and surface area less than 100 m2/g, and φ>0, for example Z less than 10 and >70% microporosity, and wherein the silicon-carbon composite also comprises 30%-60% silicon, and surface area less than 50 m2/g, and φ>0, for example Z less than 10 and >70% microporosity, and wherein the silicon-carbon composite also comprises 30%-60% silicon, and surface area less than 30 m2/g, and φ>0, for example Z less than 10 and >70% microporosity, and wherein the silicon-carbon composite also comprises 30%-60% silicon, and surface area less than 10 m2/g, and φ>0, for example Z less than 10 and >70% microporosity, and wherein the silicon-carbon composite also comprises 30%-60% silicon, and surface area less than 5 m2/g, and φ≥0.

In certain embodiments, the silicon-carbon composite material comprises a Z less than 10 and a carbon scaffold with >70% microporosity, and wherein the silicon-carbon composite also comprises 40%-60% silicon, and surface area less than 100 m2/g, and φ>0, for example Z less than 10 and >70% microporosity, and wherein the silicon-carbon composite also comprises 40%-60% silicon, and surface area less than 50 m2/g, and φ>0, for example Z less than 10 and >70% microporosity, and wherein the silicon-carbon composite also comprises 40%-60% silicon, and surface area less than 30 m2/g, and φ>0, for example Z less than 10 and >70% microporosity, and wherein the silicon-carbon composite also comprises 40%-60% silicon, and surface area less than 10 m2/g, and φ>0, for example Z less than 10 and >70% microporosity, and wherein the silicon-carbon composite also comprises 40%-60% silicon, and surface area less than 5 m2/g, and φ>0.

In certain embodiments, the silicon-carbon composite material comprises a Z less than 10 and a carbon scaffold with >80% microporosity, and wherein the silicon-carbon composite also comprises 30%-60% silicon, and surface area less than 100 m2/g, and φ≥0.1, for example Z less than 10 and >80% microporosity, and wherein the silicon-carbon composite also comprises 30%-60% silicon, and surface area less than 50 m2/g, and φ≥0.1, for example Z less than 10 and >80% microporosity, and wherein the silicon-carbon composite also comprises 30%-60% silicon, and surface area less than 30 m2/g, and φ≥0.1, for example Z less than 10 and >80% microporosity, and wherein the silicon-carbon composite also comprises 30%-60% silicon, and surface area less than 10 m2/g, and φ≥0.1, for example Z less than 10 and >80% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >80% microporosity, and wherein the silicon-carbon composite also comprises 40%-60% silicon, and surface area less than 100 m2/g, and φ≥0.1, for example Z less than 10 and >80% microporosity, and wherein the silicon-carbon composite also comprises 40%-60% silicon, and surface area less than 50 m2/g, and φ≥0.1, for example Z less than 10 and >80% microporosity, and wherein the silicon-carbon composite also comprises 40%-60% silicon, and surface area less than 30 m2/g, and φ≥0.1, for example Z less than 10 and >80% microporosity, and wherein the silicon-carbon composite also comprises 40%-60% silicon, and surface area less than 10 m2/g, and φ≥0.1, for example Z less than 10 and >80% microporosity, and wherein the silicon-carbon composite also comprises 40%-60% silicon, and surface area less than 5 m2/g, and φ≥0.1.

In certain embodiments, the silicon-carbon composite material comprises a Z less than 10 and a carbon scaffold with >80% microporosity, and wherein the silicon-carbon composite also comprises 30%-60% silicon, and surface area less than 100 m2/g, and φ>0, for example Z less than 10 and >80% microporosity, and wherein the silicon-carbon composite also comprises 30%-60% silicon, and surface area less than 50 m2/g, and φ>0, for example Z less than 10 and >80% microporosity, and wherein the silicon-carbon composite also comprises 30%-60% silicon, and surface area less than 30 m2/g, and φ>0, for example Z less than 10 and >80% microporosity, and wherein the silicon-carbon composite also comprises 30%-60% silicon, and surface area less than 10 m2/g, and φ>0, for example Z less than 10 and >80% microporosity, and wherein the silicon-carbon composite also comprises 30%-60% silicon, and surface area less than 5 m2/g, and φ>0.

In certain embodiments, the silicon-carbon composite material comprises a Z less than 10 and a carbon scaffold with >80% microporosity, and wherein the silicon-carbon composite also comprises 40%-60% silicon, and surface area less than 100 m2/g, and φ>0, for example Z less than 10 and >80% microporosity, and wherein the silicon-carbon composite also comprises 40%-60% silicon, and surface area less than 50 m2/g, and φ>0, for example Z less than 10 and >80% microporosity, and wherein the silicon-carbon composite also comprises 40%-60% silicon, and surface area less than 30 m2/g, and φ>0, for example Z less than 10 and >80% microporosity, and wherein the silicon-carbon composite also comprises 40%-60% silicon, and surface area less than 10 m2/g, and φ>0, for example Z less than 10 and >80% microporosity, and wherein the silicon-carbon composite also comprises 40%-60% silicon, and surface area less than 5 m2/g, and φ>0.

In certain embodiments, the silicon-carbon composite material comprises a Z less than 10 and a carbon scaffold with >90% microporosity, and wherein the silicon-carbon composite also comprises 30%-60% silicon, and surface area less than 100 m2/g, and φ≥0.1, for example Z less than 10 and >90% microporosity, and wherein the silicon-carbon composite also comprises 30%-60% silicon, and surface area less than 50 m2/g, and φ≥0.1, for example Z less than 10 and >90% microporosity, and wherein the silicon-carbon composite also comprises 30%-60% silicon, and surface area less than 30 m2/g, and φ≥0.1, for example Z less than 10 and >90% microporosity, and wherein the silicon-carbon composite also comprises 30%-60% silicon, and surface area less than 10 m2/g, and φ≥0.1, for example Z less than 10 and >90% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >90% microporosity, and wherein the silicon-carbon composite also comprises 40%-60% silicon, and surface area less than 100 m2/g, and φ≥0.1, for example Z less than 10 and >90% microporosity, and wherein the silicon-carbon composite also comprises 40%-60% silicon, and surface area less than 50 m2/g, and φ≥0.1, for example Z less than 10 and >90% microporosity, and wherein the silicon-carbon composite also comprises 40%-60% silicon, and surface area less than 30 m2/g, and φ≥0.1, for example Z less than 10 and >90% microporosity, and wherein the silicon-carbon composite also comprises 40%-60% silicon, and surface area less than 10 m2/g, and φ≥0.1, for example Z less than 10 and >90% microporosity, and wherein the silicon-carbon composite also comprises 40%-60% silicon, and surface area less than 5 m2/g, and φ≥0.1.

In certain embodiments, the silicon-carbon composite material comprises a Z less than 10 and a carbon scaffold with >90% microporosity, and wherein the silicon-carbon composite also comprises 30%-60% silicon, and surface area less than 100 m2/g, and φ>0, for example Z less than 10 and >90% microporosity, and wherein the silicon-carbon composite also comprises 30%-60% silicon, and surface area less than 50 m2/g, and φ>0, for example Z less than 10 and >90% microporosity, and wherein the silicon-carbon composite also comprises 30%-60% silicon, and surface area less than 30 m2/g, and φ>0, for example Z less than 10 and >90% microporosity, and wherein the silicon-carbon composite also comprises 30%-60% silicon, and surface area less than 10 m2/g, and φ>0, for example Z less than 10 and >90% microporosity, and wherein the silicon-carbon composite also comprises 30%-60% silicon, and surface area less than 5 m2/g, and φ>0.

In certain embodiments, the silicon-carbon composite material comprises a Z less than 10 and a carbon scaffold with >90% microporosity, and wherein the silicon-carbon composite also comprises 40%-60% silicon, and surface area less than 100 m2/g, and φ>0, for example Z less than 10 and >90% microporosity, and wherein the silicon-carbon composite also comprises 40%-60% silicon, and surface area less than 50 m2/g, and φ>0, for example Z less than 10 and >90% microporosity, and wherein the silicon-carbon composite also comprises 40%-60% silicon, and surface area less than 30 m2/g, and φ>0, for example Z less than 10 and >90% microporosity, and wherein the silicon-carbon composite also comprises 40%-60% silicon, and surface area less than 10 m2/g, and φ>0, for example Z less than 10 and >90% microporosity, and wherein the silicon-carbon composite also comprises 40%-60% silicon, and surface area less than 5 m2/g, and φ>0.

In certain embodiments, the silicon-carbon composite material comprises a Z less than 10 and a carbon scaffold with >95% microporosity, and wherein the silicon-carbon composite also comprises 30%-60% silicon, and surface area less than 100 m2/g, and φ≥0.1, for example Z less than 10 and >95% microporosity, and wherein the silicon-carbon composite also comprises 30%-60% silicon, and surface area less than 50 m2/g, and φ≥0.1, for example Z less than 5 and >95% microporosity, and wherein the silicon-carbon composite also comprises 30%-60% silicon, and surface area less than 30 m2/g, and φ≥0.1, for example Z less than 10 and >95% microporosity, and wherein the silicon-carbon composite also comprises 30%-60% silicon, and surface area less than 10 m2/g, and φ≥0.1, for example Z less than 10 and >95% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >95% microporosity, and wherein the silicon-carbon composite also comprises 40%-60% silicon, and surface area less than 100 m2/g, and φ≥0.1, for example Z less than 10 and >95% microporosity, and wherein the silicon-carbon composite also comprises 40%-60% silicon, and surface area less than 50 m2/g, and φ≥0.1, for example Z less than 10 and >95% microporosity, and wherein the silicon-carbon composite also comprises 40%-60% silicon, and surface area less than 30 m2/g, and φ≥0.1, for example Z less than 10 and >95% microporosity, and wherein the silicon-carbon composite also comprises 40%-60% silicon, and surface area less than 10 m2/g, and φ≥0.1, for example Z less than 10 and >95% microporosity, and wherein the silicon-carbon composite also comprises 40%-60% silicon, and surface area less than 5 m2/g, and φ≥0.1.

In certain embodiments, the silicon-carbon composite material comprises a Z less than 10 and a carbon scaffold with >95% microporosity, and wherein the silicon-carbon composite also comprises 30%-60% silicon, and surface area less than 100 m2/g, and φ≥0.1, for example Z less than 10 and >95% microporosity, and wherein the silicon-carbon composite also comprises 30%-60% silicon, and surface area less than 50 m2/g, and φ≥0.1, for example Z less than 10 and >95% microporosity, and wherein the silicon-carbon composite also comprises 30%-60% silicon, and surface area less than 30 m2/g, and φ≥0.1, for example Z less than 10 and >95% microporosity, and wherein the silicon-carbon composite also comprises 30%-60% silicon, and surface area less than 10 m2/g, and φ≥0.1, for example Z less than 10 and >95% microporosity, and wherein the silicon-carbon composite also comprises 30%-60% silicon, and surface area less than 5 m2/g, and φ≥0.1.

In certain embodiments, the silicon-carbon composite material comprises a Z less than 10 and a carbon scaffold with >95% microporosity, and wherein the silicon-carbon composite also comprises 40%-60% silicon, and surface area less than 100 m2/g, and φ>0, for example Z less than and >95% microporosity, and wherein the silicon-carbon composite also comprises 40%-60% silicon, and surface area less than 50 m2/g, and φ>0, for example Z less than 10 and >95% microporosity, and wherein the silicon-carbon composite also comprises 40%-60% silicon, and surface area less than 30 m2/g, and φ>0, for example Z less than 10 and >95% microporosity, and wherein the silicon-carbon composite also comprises 40%-60% silicon, and surface area less than 10 m2/g, and φ>0, for example Z less than 10 and >95% microporosity, and wherein the silicon-carbon composite also comprises 40%-60% silicon, and surface area less than 5 m2/g, and φ>0.

In certain embodiments, the silicon-carbon composite material comprises a Z less than 10 and a carbon scaffold with >80% microporosity, and wherein the silicon-carbon composite also comprises 30%-60% silicon, and surface area less than 30 m2/g, φ≥0.15, and an average Coulombic efficiency≥0.9969, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.15, and an average Coulombic efficiency≥0.9970, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.15, and an average Coulombic efficiency≥0.9975, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.15, and an average Coulombic efficiency≥0.9980, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.15, and an average Coulombic efficiency≥0.9985, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.15, and an average Coulombic efficiency≥0.9990, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.15, and an average Coulombic efficiency≥0.9995, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.15, and an average Coulombic efficiency≥0.9999.

In certain embodiments, the silicon-carbon composite material comprises a Z less than 10 and a carbon scaffold with >80% microporosity, and wherein the silicon-carbon composite also comprises 30%-60% silicon, and surface area less than 30 m2/g, φ≥0.20, and an average Coulombic efficiency≥0.9969, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.20, and an average Coulombic efficiency≥0.9970, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.20, and an average Coulombic efficiency≥0.9975, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.20, and an average Coulombic efficiency≥0.9980, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.20, and an average Coulombic efficiency≥0.9985, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.20, and an average Coulombic efficiency≥0.9990, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.20, and an average Coulombic efficiency≥0.9995, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.20, and an average Coulombic efficiency≥0.9999.

In certain embodiments, the silicon-carbon composite material comprises a Z less than 10 and a carbon scaffold with >80% microporosity, and wherein the silicon-carbon composite also comprises 30%-60% silicon, and surface area less than 30 m2/g, φ≥0.25, and an average Coulombic efficiency≥0.9969, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.25, and an average Coulombic efficiency≥0.9970, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.25, and an average Coulombic efficiency≥0.9975, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.25, and an average Coulombic efficiency≥0.9980, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.25, and an average Coulombic efficiency≥0.9985, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.25, and an average Coulombic efficiency≥0.9990, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.25, and an average Coulombic efficiency≥0.9995, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.25, and an average Coulombic efficiency≥0.9999.

In certain embodiments, the silicon-carbon composite material comprises a Z less than 10 and a carbon scaffold with >80% microporosity, and wherein the silicon-carbon composite also comprises 30%-60% silicon, and surface area less than 30 m2/g, φ≥0.3, and an average Coulombic efficiency≥0.9969, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.3, and an average Coulombic efficiency≥0.9970, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.3, and an average Coulombic efficiency≥0.9975, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.3, and an average Coulombic efficiency≥0.9980, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.3, and an average Coulombic efficiency≥0.9985, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.3, and an average Coulombic efficiency≥0.9990, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.3, and an average Coulombic efficiency≥0.9995, for example the silicon-carbon composite material comprises a Z less than 10 and a carbon scaffold with >80% microporosity, and wherein the silicon-carbon composite also comprises 30%-60% silicon, and surface area less than 30 m2/g, φ≥0.3, and an average Coulombic efficiency≥0.9999.

### Example 4

### Creation of Primary Spherical Pyrolyzed Carbon Particles in the Absence of Preferential Exclusion Agent.

Various samples were produced according to Table 8. Sucrose was weighed out into Teflon lined autoclave followed by addition of deionized water. The solution was stirred until the sucrose was fully dissolved then the autoclave was sealed and placed in a convection oven at elevated temperature. The vessel proceeds to dwell at temperature. During this time, the reaction proceeds via a hydrothermal condensation mechanism. After dwell, the vessel was removed from the oven and allowed to fully cool to room temperature. The lid was slowly opened to allow residual vapor pressure to vent and a brown particulate hydrothermal char (HTC) was harvested from the vessel. The HTC was rinsed twice with deionized water over a filter then subsequently dried at 80° C. for >2 hours, and subsequently sieved through a 25 micron size sieve. The dried HTC is then loaded into an alumina crucible and pyrolyzed in a tube furnace at 900° ° C. for 1 hour under a constant flow of nitrogen gas. The furnace is subsequently cooled to room temperature and the pyrolyzed spherical carbon product is obtained.

TABLE 8
Production of various samples of primary spherical pyrolyzed carbon
particles in the absence of preferential exclusion agent

| | | | | | HTC | Sieve | Pyrolysis | Overall |
|---|---|---|---|---|---|---|---|---|
| Carbon | Sucrose | Water | Temp | Dwell | Yield | Yield | Yield | Yield |
| Scaffold | (g) | (ml) | (C.) | (h) | (%) | (%) | (%) | (%) |
| 10 | 3 | 20 | 180 | 20 | 16.0 | 16.0 | 45.9 | 1.2 |
| 11 | 36 | 110 | 200 | 24 | 42.8 | 10.5 | 47.0 | 2.1 |
| 12 | 36 | 110 | 200 | 24 | 48.9 | 22.4 | 48.8 | 5.3 |
| | | | | w/stirring | | | | |

The various samples of primary spherical pyrolyzed carbon particles produced in the absence of preferential exclusion agent were characterized as summarized in Table 9.

TABLE 9
Characterization of various samples of primary spherical pyrolyzed
carbon particles in the absence of preferential exclusion agent.

| | | | | Surface | Pore | |
|---|---|---|---|---|---|---|
| Carbon | Dv1 | Dv50 | Dv99 | Area | Volume | |
| Scaffold | (μm) | (μm) | (μm) | (m2/g) | (cm3/g) | % Micro/Meso/Macropores |
| 10 | 4.4 | 16.4 | 41.2 | 934 | 0.226 | 100/0.0/0.0 |
| 11 | 4.5 | 16.1 | 40.7 | 799 | 0.186 | 99.7/0.1/0.2 |
| 12 | 4.7 | 16.4 | 47.0 | 806 | 0.191 | 100/0.0/0.0 |

### Example 5

### Creation of Primary Spherical Pyrolyzed Carbon Particles in the Absence of Preferential Exclusion Agent.

Various samples were produced according to Table 10. Sucrose was weighed out into Teflon lined autoclave followed by addition of deionized water containing varying amounts of poly(acrylic acid) (PAA) as the preferential exclusion agent. The solution was stirred until the sucrose was fully dissolved then the autoclave was sealed and placed in a convection oven at elevated temperature. The vessel proceeds to dwell at temperature. During this time, the reaction proceeds via a hydrothermal condensation mechanism. After dwell, the vessel was removed from the oven and allowed to fully cool to room temperature. The lid was slowly opened to allow residual vapor pressure to vent and a brown particulate hydrothermal char (HTC) was harvested from the vessel. The HTC was rinsed twice with deionized water over a filter then subsequently dried at 80° C. for >2 hours, and subsequently sieved through a 25 micron size sieve. The dried HTC is then loaded into an alumina crucible and pyrolyzed in a tube furnace at 900° C. for 1 hour under a constant flow of nitrogen gas. The furnace is subsequently cooled to room temperature and the pyrolyzed spherical carbon product is obtained.

TABLE 10
Production of sample of primary spherical pyrolyzed carbon
particles in the presence of preferential exclusion agent.

| | | | | | | HTC | Sieve | Pyrolysis |
|---|---|---|---|---|---|---|---|---|
| Carbon | Sucrose | Water | Temp | Sucrose:PAA | Dwell | Yield | Yield | Yield |
| Scaffold | (g) | (ml) | (C.) | (m:m) | (h) | (%) | (%) | (%) |
| 13 | 36 | 110 | 200 | 800:1 | 24 | 42.6 | 22.7 | 50.1 |
| 14 | 36 | 110 | 200 | 400:1 | 24 | 43.7 | 34.5 | 49.0 |
| 15 | 36 | 110 | 210 | 100:1 | 26 | 42.0 | 19.4 | 50.8 |
| 16 | 68 | 207 | 200 | 1000:1 | 20.5 | 42.5 | 23.6 | 51.0 |

As can be seen from the data in the table, the overall yields trended higher for sample produced in the presence of preferential exclusion agent, up to 7.4% for Carbon Scaffold 14. The Dv1, Dv50 and Dv99 for Carbon Scaffold 13 were 1.6 μm, 9.5 μm, and 33.0 μm, respectively, and the Dv1, Dv50 and Dv99 for Carbon Scaffold 14 were 1.6 μm, 8.6 μm, and 40.4 μm, respectively.

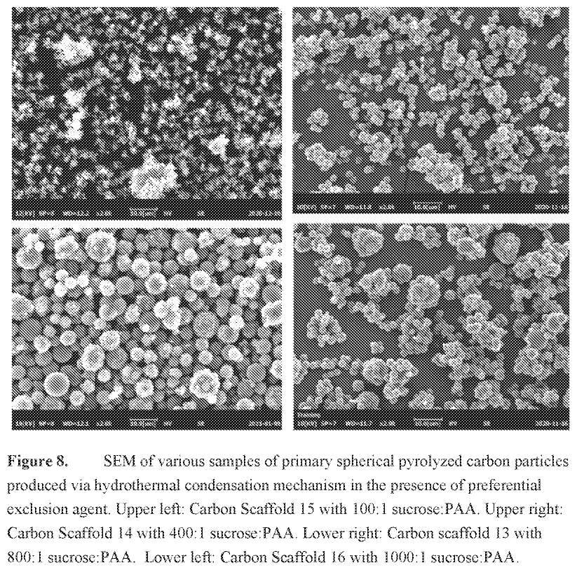

FIG. 8 depicts the SEM for the various samples according to Example 5. The SEM images reveal that the addition of the PAA as the preferential exclusion agent controls the morphology and particle size of the carbon scaffold particles. At the lowest amount of PAA added, namely 1000:1 sucrose:PAA (lower left image in FIG. 8, Carbon Scaffold 16), the particles appeared dimpled, with most particles appearing in size 6-13 μm. As the amount of PAA added increased to 800:1 sucrose:PAA (lower right image in FIG. 8, Carbon Scaffold 13), the particles appeared more smooth, with most particles appearing in size 2.3-2.9 μm. As the amount of PAA added was further increased to 400:1 sucrose:PAA (upper right image in FIG. 8, Carbon Scaffold 14), the particles appeared more smooth, with most particles appearing in size 2.3-2.9 μm. Finally, at the highest amount of PAA added of 100:1 sucrose:PAA (upper left image in FIG. 8, Carbon Scaffold 15), the particles were no longer spherical in shape and shoed very irregular morphology.

In certain embodiments, the ratio of polyol:surfactant ratio is greater than 1000:1. In some embodiments the polyol:surfactant ratio is between 1000:1 and 800:1. In still further embodiments the polyol:surfactant ration is between 800:1 and 600:1; 600:1 and 500:1; 500:1 and 400:1; 400:1 and 300:1; 300:1 and 200:1; 200:1 and 100:1. In some embodiments the polyol:surfactant ratio is less than 100:1.

### Example 6

### Creation of Primary Spherical Activated Carbon Particles.

Carbon Scaffold 13, Carbon Scaffold 14, and Carbon Scaffold 16 were activated by steam to increase the available porosity, resulting in creation of Scaffold Sample 17, Scaffold Sample 18, and Scaffold Sample 19. In a typical experiment 1 gram of the pyrolyzed material was placed in an alumina crucible then placed in the center hot zone of a horizontal tube furnace. The furnace was purged with nitrogen gas flow (˜500 sccm) that was routed through a bubbler (flask heated to 200° C. set point) upstream of the furnace containing distilled water. This acted as a source of steam to activate the carbon via the reaction C+H2O=>CO+H2. The temperature of the furnace was ramped to 900° ° C. at 10° C./min and held for varying amounts of time. The furnace was then cooled ambiently and the sample was removed for analysis. A summary of the samples and their properties is presented in Table 11.

TABLE 11
Production of sample of primary spherical activated carbon
particles in the presence of preferential exclusion agent.

| | Activation | | Surface | Pore | % |
|---|---|---|---|---|---|
| Carbon | Temp | Activation | Area | Volume | Micro/Meso/ |
| Scaffold | (C.) | time (h) | (m2/g) | (cm3/g) | Macropores |
| 17 | 900 | 2.2 | 1656 | 0.692 | 97.7/2.2/0.1 |
| 18 | 900 | 2 | 930 | 0.228 | 97.7/2.2/0.1 |
| 19 | 900 | 4.4 | 2283 | 0.9899 | 86.1/13.7/0.2 |

### Example 7

### Creation of Primary Spherical Group 14 Composite Particles.

Carbon Scaffold 13 was subjected to CVI using silane gas to deposit silicon within the carbon porosity. The resulting material produced was Silicon-Carbon Composite 21, whose properties are listed in Table 12. In a typical experiment 0.2 grams of the activated material was placed in an alumina crucible then placed in the center hot zone of a horizontal tube furnace. The furnace was purged with nitrogen gas flow (˜500 sccm) for 10 min then ramped to 475° C. at 20° C./min. The furnace temperature was allowed to stabilize for 30 min at peak temperature then the gas flow was switched to 1.3 mol % SiH4/N2 mixed gas at 580 sccm for 1.75 hours. Following deposition, gas was switched back to pure nitrogen and the furnace was cooled ambiently. When the furnace temp reached <60° ° C. the sample was removed for analysis.

TABLE 12
Properties of Silicon-Composite 21.

| Silicon- | | | | | | | |
|---|---|---|---|---|---|---|---|
| Carbon | Carbon | Surface | Si | | | | |
| Composite | Scaffold | Area | content | | Dv1 | Dv50 | DV99 |
| # | # | (m2/g) | (%) | Z | (μm) | (μm) | (μm) |
| 21 | 13 | 156 | 48.3 | 2.4 | 0.8 | 9.5 | 42.3 |

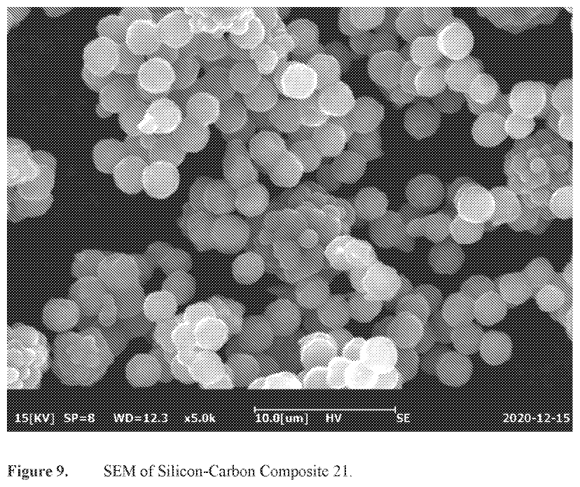

The measured particle size distribution for the Silicon-Carbon Composite 21 was very similar to the starting Carbon Scaffold 13; the latter exhibited Dv1, Dv50 and Dv99 of 0.8 μm, 10.3 μm, and 48.7 μm, respectively. The SEM for Silicon-Carbon Composite 21 is depicted in FIG. 9.

### Example 8

### Creation of Primary Spherical Activated Carbon Particles in the Absence of Preferential Exclusion Agent.

Primary spherical activated carbon particles were produced according to Table 13. Sucrose was weighed out into Teflon lined autoclave followed by addition of deionized water. The samples were prepared without a preferential exclusion agent. The solution was stirred until the sucrose was fully dissolved then the autoclave was sealed and placed in a convection oven at elevated temperature. The vessel proceeds to dwell at temperature. During this time, the reaction proceeds via a hydrothermal condensation mechanism. After dwell, the vessel was removed from the oven and allowed to fully cool to room temperature. The lid was slowly opened to allow residual vapor pressure to vent, and a particulate hydrothermal char (HTC) was harvested from the vessel. The HTC was rinsed twice with deionized water over a filter then subsequently dried at 80° C. for >2 hours. The dried HTC is then loaded into an alumina crucible and pyrolyzed in a tube furnace at 900° C. for 1 hour under a constant flow of nitrogen gas. The furnace is subsequently cooled to room temperature and the pyrolyzed spherical carbon product is obtained.

TABLE 13
Production of sample of primary spherical pyrolyzed and activated carbon particle.

| | | | | | | HTC | Pyrolysis | Activation |
|---|---|---|---|---|---|---|---|---|
| Carbon | Sucrose | Water | Temp | Sucrose:Surfactant | Dwell | Yield | Yield | Yield |
| Scaffold | (g) | (ml) | (C.) | (m:m) | (h) | (%) | [wt %] | [wt %] |
| 22 | 23 | 110 | 200 | N/A | 24 | 42.3 | 55.0 | 50.8 |
| 23 | 30 | 110 | 210 | N/A | 24 | 45 | 52.2 | 57.8 |

Following pyrolysis, the particles were activated by steam to increase the available porosity. In a typical experiment, 1 gram of the pyrolyzed material was placed in an alumina crucible then placed in the center hot zone of a horizontal tube furnace. The furnace was purged with nitrogen gas flow (˜500 sccm) that was routed through a bubbler (flask heated to 200° C. set point) upstream of the furnace containing distilled water. This acted as a source of steam to activate the carbon via the reaction C+H2O=>CO+H2. The temperature of the furnace was ramped to 900° C. at 10° C./min and held for varying amounts of time. The furnace was then cooled ambiently and the sample was removed for analysis.

Subsequent to the activation by steam, the activated carbon scaffolds as described in Table 13 were employed to produce a variety of silicon-carbon composite materials employing the CVI methodology in a static bed configuration as generally described in Example 1. The resulting physiochemical properties of the silicon-carbon composite materials are represented in Table 14 along with a comparison of silicon-carbon composite materials derived from non-polyol precursor materials which are designated as Silicon-Carbon Composites C1 and C2 in Table 14.

TABLE 14
Primary spherical Si—C composite particle properties.

| Silicon- | | | | | | | | |
|---|---|---|---|---|---|---|---|---|
| Carbon | Carbon | Surface | | Si | | | | |
| Composite | Scaffold | Area | PV | content | | Dv1 | Dv50 | DV99 |
| # | # | (m2/g) | (cm3/g) | (%) | Z | (μm) | (μm) | (μm) |
| C1 | Nonpolyol | 6.75 | 0.012 | 47.94 | 2.53 | — | — | — |
| | precursor | | | | | | | |
| | 1 | | | | | | | |
| C2 | Nonpolyol | 4.0 | 0.003 | 45.53 | 0.66 | — | — | — |
| | precursor | | | | | | | |
| | 2 | | | | | | | |
| 22 | 22 | 0.81 | 0.0019 | 48.7 | 0.76 | 24 | 42.3 | 55.0 |
| 23 | 23 | 0.75 | 0.0011 | 41.35 | 0.7 | 3.2 | 22.2 | 58.3 |

The resulting silicon-carbon composites were uniform in appearance with no visible agglomeration of particles and a soft texture. Without being bound by theory, in some instances the polyol-based Si—C composites demonstrated lower surface areas after silicon CVI than the comparative Si—C composites created from the non-polyol precoursors as shown in Table 14. In some cases, surface area was less than 1.0 m2/g but greater than 0.5 m2/g.

Silicon-Carbon Composites 22 and 23 were also tested according to the methodology generally described in Example 2. Physicochemical and electrochemical properties for these silicon-carbon composite materials are presented in Table 15.

TABLE 15
Primary spherical Si—C composite particle properties.

| Silicon- | | | First | |
|---|---|---|---|---|
| Carbon | Carbon | Max | Cycle | Average |
| Composite | Scaffold | Capacity | Efficiency | CE |
| # | # | (mAh/g) | (%) | (7-20) |
| 22 | 22 | 1673 | 88.9 | 0.9998 |
| 23 | 23 | 1990 | 91.6 | 0.9967 |

### Expressed Embodiments

Embodiment 1. A Group14 composite comprising a plurality of primary particles comprising Group14 elements silicon and carbon, wherein the particles exhibit a spherical morphology, Dv50 less than or equal to 10 μm, Z<10, and φ≥0.15, φ=(Max peak height dQ/dV in Regime I)/(Max peak height dQ/dV in Regime III), wherein dQ/dV is measured in a half-cell coin cell, and regime I is 0.8V-0.4V and Regime III is 0.15V-0V.

Embodiment 2. A Group14 composite comprising a plurality of primary particles comprising Group14 elements silicon and carbon, wherein the particles exhibit a spherical morphology, Dv50 less than or equal to 10 μm, Z<10, and φ≥0.2, φ=(Max peak height dQ/dV in Regime I)/(Max peak height dQ/dV in Regime III), wherein dQ/dV is measured in a half-cell coin cell, and regime I is 0.8V-0.4V and Regime III is 0.15V-0V.

Embodiment 3. A Group14 composite comprising a plurality of primary particles comprising Group14 elements silicon and carbon, wherein the particles exhibit a spherical morphology, Dv50 less than or equal to 10 μm, Z<10, and φ≥0.3, φ=(Max peak height dQ/dV in Regime I)/(Max peak height dQ/dV in Regime III), wherein dQ/dV is measured in a half-cell coin cell, and regime I is 0.8V-0.4V and Regime III is 0.15V-0V.

Embodiment 4. A Group14 composite comprising: (a) a plurality of porous carbon primary particles derived from a polyol, wherein the plurality of porous carbon particles exhibit a spherical morphology; (b) silicon impregnated within pores of the porous carbon primary particles; (c) Dv50 is less than or equal to 10 μm; (d) Z<10; and (e) phi (+)≥0.15, wherein dQ/dV is measured in a half-cell coin cell, and regime I is 0.8V-0.4V and Regime III is 0.15V-0V. Embodiment 5. The Group14 composite of Embodiment 4 wherein φ≥0.2.

Embodiment 6. The Group 14 composite of Embodiment 4 wherein φ≥0.3.

Embodiment 7. The Group 14 composite of any of the embodiments from Embodiment 1 to Embodiment 6 wherein Dv50 less than or equal to 5 μm.

Embodiment 8. The Group 14 composite of any of the embodiments from Embodiment 1 to Embodiment 7, wherein individual particles of the porous carbon primary particles are discreate, nonagglomerated particles.

Embodiment 9. The Group14 composite of any of the embodiments from Embodiment 1 to Embodiment 8 wherein Z<5.

Embodiment 10. The Group 14 composite of any of the embodiments from Embodiment 1 to Embodiment 9 further comprising a surface area<50 m2/g.

Embodiment 11. The Group 14 composite of the embodiments from Embodiment 1 to Embodiment 10, further comprising: (a) a total pore volume of greater than 0.6 cm3/g; (b) a volume faction of micropores in the range from 20-50% and a volume fraction of mesopores in the range of 50-80%; and (c) a fractional pore volume of pores at or below 10 nm that comprises at least 75% of the total pore volume ranging from 5 nm to 20 μm.

Embodiment 12. The Group 14 composite of any of the embodiments from Embodiment 1 to Embodiment 11, wherein the weight percent of silicon to the porous carbon primary particles ranges from 10% to 80%.

Embodiment 13. A Group14 composite comprising a plurality of primary particles comprising Group 14 elements silicon and carbon, comprising 30% to 60% silicon by weight, wherein the particles exhibit a spherical morphology, Dv50 less than or equal to 10 μm, Z<10, and φ≥0.15, φ=(Max peak height dQ/dV in Regime I)/(Max peak height dQ/dV in Regime III), wherein dQ/dV is measured in a half-cell coin cell, and regime I is 0.8V-0.4V and Regime III is 0.15V-0V.

Embodiment 14. A Group14 composite comprising a plurality of primary particles comprising Group14 elements silicon and carbon, comprising 30% to 60% silicon by weight, wherein the particles exhibit a spherical morphology, Dv50 less than or equal to 10 μm, Z<10, and φ≥0.2, φ=(Max peak height dQ/dV in Regime I)/(Max peak height dQ/dV in Regime III), wherein dQ/dV is measured in a half-cell coin cell, and regime I is 0.8V-0.4V and Regime III is 0.15V-0V.

Embodiment 15. A Group 14 composite comprising a plurality of primary particles comprising Group14 elements silicon and carbon, comprising 30% to 60% silicon by weight, wherein the particles exhibit a spherical morphology, Dv50 less than or equal to 10 μm, Z<10, and φ≥0.3, φ=(Max peak height dQ/dV in Regime I)/(Max peak height dQ/dV in Regime III), wherein dQ/dV is measured in a half-cell coin cell, and regime I is 0.8V-0.4V and Regime III is 0.15V-0V.

Embodiment 16. A Group 14 composite comprising: (a) a plurality of primary particles comprising Group 14 elements silicon and carbon, wherein the primary particles have a sphericity of at least 0.5, and wherein each particle comprises a porous carbon scaffold; (b) 30% to 60% silicon by weight; (c) Dv50 is less than or equal to 10 μm; (d) Z<10; and (e) phi (φ)≥0.15, wherein dQ/dV is measured in a half-cell coin cell, and regime I is 0.8V-0.4V and Regime III is 0.15V-0V.

Embodiment 17. A Group 14 composite comprising carbon and silicon, wherein: (a) the carbon comprises a porous carbon scaffold derived from a polyol and further comprising: (i) amorphous carbon, (ii) a pore volume, wherein greater than 70% of the pore volume is comprised of pores having a diameter less than 2 nm, and (iii) a Dv90 less 50 nm; (b) the silicon comprises: (i) amorphous, nano-sized silicon embedded within the pore volume of the porous carbon scaffold; and (c) the Group 14 composite further comprises: (i) 30% to 60% silicon by weight, (ii) Dv50 is less than or equal to 10 μm, (iii) Z<10, and (iv) phi (φ)≥0.15, wherein dQ/dV is measured in a half-cell coin cell, and regime I is 0.8V-0.4V and Regime III is 0.15V-0V.

Embodiment 18. The Group 14 composite of any of the embodiments from Embodiment 1 to Embodiment 10 and from Embodiment 12 to Embodiment 17, further comprising a carbon scaffold comprising a pore volume, wherein the pore volume comprises >70% microporosity.

Embodiment 19. The Group 14 composite of any of the embodiments from Embodiment 1 to Embodiment 10 and from Embodiment 12 to Embodiment 17, further comprising a carbon scaffold comprising a pore volume, wherein the pore volume comprises >80% microporosity.

Embodiment 20. The Group 14 composite of any of the embodiments from Embodiment 1 to Embodiment 10 and from Embodiment 12 to Embodiment 17, further comprising a carbon scaffold comprising a pore volume, wherein the pore volume comprises >90% microporosity.

Embodiment 21. The Group 14 composite of any of the embodiments from Embodiment 1 to Embodiment 20, wherein the Group14 composite comprises a capacity of greater than 900 mAh/g.

Embodiment 22. The Group 14 composite of any of the embodiments from Embodiment 1 to Embodiment 20, wherein the Group14 composite comprises a capacity of greater than 1300 mAh/g.

Embodiment 23. The Group 14 composite of any of the embodiments from Embodiment 1 to Embodiment 20, wherein the Group 14 composite comprises a capacity of greater than 1600 mAh/g.

Embodiment 24. The Group 14 composite of any of the embodiments from Embodiment 1 to Embodiment 23, wherein the Group 14 composite comprises an average Coulombic efficiency of ≥0.9970.

Embodiment 25. The Group14 composite of any of the embodiments from Embodiment 1 to Embodiment 23, wherein the Group14 composite comprises an average Coulombic efficiency of ≥0.9980.

Embodiment 26. The Group 14 composite of any of the embodiments from Embodiment 1 to Embodiment 23, wherein the Group14 composite comprises an average Coulombic efficiency of ≥0.9985.

Embodiment 27. The Group14 composite of any of the embodiments from Embodiment 1 to Embodiment 23, wherein the Group14 composite comprises an average Coulombic efficiency of ≥0.9990.

Embodiment 28. The Group 14 composite of any of the embodiments from Embodiment 1 to Embodiment 23, wherein the Group 14 composite comprises an average Coulombic efficiency of ≥0.9995.

Embodiment 29. The Group 14 composite of any of the embodiments from Embodiment 1 to Embodiment 23, wherein the Group14 composite comprises an average Coulombic efficiency of ≥0.9995.

Embodiment 30. The Group 14 composite of any of the embodiments from Embodiment 1 to Embodiment 23, wherein the Group14 composite comprises an average Coulombic efficiency of ≥0.9999.

Embodiment 31. The Group 14 composite of any of the embodiments from Embodiment 1 to Embodiment 30, wherein the primary particles have an average sphericity of at least 0.5, at least 0.55, at least 0.65, at least 0.7, at least 0.75, or at least 0.8.

Embodiment 32. The Group 14 composite of any of the embodiments from Embodiment 1 to Embodiment 31, wherein primary particles comprising the Group 14 composite do not require sieving or milling in their manufacture.

Embodiment 33. A Group14 composite wherein: (a) the carbon comprises a porous carbon scaffold comprising (i) amorphous carbon, (ii) a pore volume, wherein greater than 70% of the pore volume resides in pores having a diameter less than 2 nm, and (iii) a DPv90 less 50 nm; (b) the silicon comprises (i) amorphous, nano-sized silicon embedded within the pore volume of the carbon scaffold; and (c) the composite comprises (i) 30% to 60% silicon by weight, (ii) Dv50 is less than or equal to 10 μm, (iii) Z<10, and (iv) φ≥0.15, φ=(Max peak height dQ/dV in Regime I)/(Max peak height dQ/dV in Regime III), wherein dQ/dV is measured in a half-cell coin cell, and regime I is 0.8V-0.4V and Regime III is 0.15V-0V.

Embodiment 34. The Group 14 composite of any of the embodiments from Embodiment 1 to Embodiment 33, further comprising a surface area less than 30 m2/g.

Embodiment 35. The Group 14 composite of any of the embodiments from Embodiment 1 to Embodiment 21 and from Embodiment 24 to Embodiment 34, further comprising a capacity of 1300 mAh/g.

Embodiment 36. The Group 14 composite of any of the embodiments from Embodiment 1 to Embodiment 21 and from Embodiment 24 to Embodiment 34, further comprising a maximum capacity of 1300 mAh/g as measured by a half-cell coin cell.

Embodiment 37. The Group 14 composite of any of the embodiments from Embodiment 1 to Embodiment 6 and from Embodiment 8 to Embodiment 36, wherein Dv50 is less than or equal to 5 μm.

Embodiment 38. The Group14 composite of any of the embodiments from Embodiment 1 to Embodiment 8 and from Embodiment 10 to Embodiment 37, wherein Z<5.

Embodiment 39. The Group 14 composite of any of the embodiments from Embodiment 7 to Embodiment 13 and from Embodiment 16 to Embodiment 38 wherein phi (φ) is greater than or equal to 0.2.

Embodiment 40. The Group 14 composite of any of the embodiments from Embodiment 7 to Embodiment 13 and from Embodiment 16 to Embodiment 38, wherein phi (φ) is greater than or equal to 0.3.

Embodiment 41. The Group 14 composite of any of the embodiments from Embodiment 1 to Embodiment 40, wherein the porous carbon scaffold has an average sphericity between 0.5 and 0.8.

Embodiment 42. An energy storage device comprising a Group14 composite described by any of the embodiments from Embodiment 1 to Embodiment 41.

Embodiment 43. A lithium-ion battery comprising a Group14 composite described by any of the embodiments from Embodiment 1 to Embodiment 41.

Embodiment 44. A lithium-silicon battery comprising a Group14 composite described by any of the embodiments from Embodiment 1 to Embodiment 41.

Embodiment 45. A process for preparing Group14 composite particles, the process comprising a. providing a polyol and an optional preferential exclusion agent in an aqueous milieu; b. heating the aqueous milieu at 150 to 250 C to produce a hydrothermal char; c. heating of the hydrothermal char to 750 C to 1050 C in the presence of an inert gas to produce pyrolyzed carbon particles; d. heating of the pyrolyzed carbon particles to 750 C to 1050 C in the presence of an activation gas to produce primary activated carbon particles, the primary activated carbon particles comprising a porous carbon framework; and e. heating the primary activated carbon particles to 350 C to 450 C in the presence of a silicon-containing gas to impregnate silicon within the porous carbon framework, wherein individual particles of the Group14 composite particles have a sphericity of greater than 0.5

Embodiment 46. A process for preparing Group 14 composite particles, the process comprising: a. providing a polyol and a preferential exclusion agent in an aqueous milieu; b. heating the mixture at 150 to 250 C to produce a hydrothermal char; c. heating of the hydrothermal char to 750 C to 1050 C in the presence of an inert gas to produce pyrolyzed carbon particles; d. heating of the pyrolyzed particles to 750 C to 1050 C in the presence of an activation gas to produce primary activated carbon particles comprising a pore volume; and e. heating the primary activated carbon particles comprising a pore volume to 350 C to 450 C in the presence of a silicon-containing gas to impregnate silicon within the porous carbon framework.

Embodiment 47. The process of any of Embodiment 45 or Embodiment 46, wherein the aqueous milieu optionally comprises a co-solvent including one or more of: an alcohol, alkanes, ethers, THF, DMSO, DMF, N-methyl pyrrolidone, glycol, and glymp.

Embodiment 48. The process of any of the embodiments from Embodiment 45 to Embodiment 47, wherein the aqueous milieu is heated to a temperature less than or equal to a decomposition temperature of the preferential exclusion agent.

Embodiment 49. The process of any of the embodiments from Embodiment 45 to Embodiment 48, wherein the aqueous milieu can be stirred or otherwise mixed to promote the formation of spherical domains throughout the aqueous milieu.

Embodiment 50. The process of any of the embodiments from Embodiment 45 to Embodiment 49, wherein the polyol is sucrose.

Embodiment 51. The process of any of the embodiments from Embodiment 45 to Embodiment 50, wherein the preferential exclusion agent is: Span 80, poly(acrylic acid), Triton X, or a combination thereof.

Embodiment 52. The process of any of the embodiments from Embodiment 45 to Embodiment 51, wherein the preferential exclusion agent is poly(acrylic acid).

Embodiment 53. The process of any of the embodiments from Embodiment 45 to Embodiment 52, wherein the ratio of polyol to preferential exclusion agent is 1000:1 or less.

Embodiment 54. The process of any of the embodiments from Embodiment 45 to Embodiment 53, wherein the inert gas is nitrogen.

Embodiment 55. The process of any of the embodiments from Embodiment 45 to Embodiment 54, wherein the activation gas is carbon dioxide, steam, or combinations thereof.

Embodiment 56. The process of any of the embodiments from Embodiment 45 to Embodiment 55, further comprising stirring the aqueous milieu.

Embodiment 57. The process of any of the embodiments from Embodiment 45 to Embodiment 56, wherein the silicon-containing gas deposits silicon onto at least a portion of a surface of the primary activated carbon particle.

Embodiment 58. The process of any of the embodiments from Embodiment 45 to Embodiment 57, wherein the fraction of silicon not impregnated within the porous carbon framework relative to the fraction of silicon impregnated within the porous carbon framework, Z, is less than 10.

Embodiment 59. The process of any of the embodiments from Embodiment 45 to Embodiment 58, wherein the impregnating silicon within the porous carbon framework comprises the deposit of a silicon nanoparticle within the interior framework of the activated carbon particles.

Embodiment 60. The process of any of the embodiments from Embodiment 45 to Embodiment 59, wherein the pyrolized carbon particles are discrete or non-agglomerated particles and do not require sieving.

Embodiment 61. The process of any of the embodiments from Embodiment 45 to Embodiment 60, wherein the Group14 composite particles are discrete particles or non-agglomerated particles and do not require sieving.

Embodiment 62. The process of any of the embodiments from Embodiment 45 to Embodiment 59, wherein both the pyrolized particles and the Group 14 composite particles are discrete particles or non-agglomerated particles and do not require sieving.

Embodiment 63. The process of any of the embodiments from Embodiment 45 to Embodiment 61, wherein the Group 14 particles further comprise two or more discrete Group14 particles and wherein the discrete Group 14 particles are not agglomerated.

Embodiment 64. The process of any of the embodiments from Embodiment 45 to Embodiment 63, wherein a pore volume of the primary activated carbon is at least 0.6 cm3/g.

Embodiment 65. The process of any of the embodiments from Embodiment 45 to Embodiment 64, wherein the silicon-containing gas is introduced via chemical vapor infusion (CVI).

Embodiment 66. The process of any of the embodiments from Embodiment 45 to Embodiment 65, wherein the silicon-containing gas is silane.

Embodiment 67. The process of any of the embodiments from Embodiment 45 to Embodiment 66, further comprising casting a slurry comprising the Group 14 particle to produce an anode electrode.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A process for preparing Group14 composite particles, the process comprising:
a. providing a polyol and an optional exclusion agent in an aqueous milieu;
b. heating the aqueous milieu at 150 to 250 C to produce a hydrothermal char;
c. heating of the hydrothermal char to 750 C to 1050 C in the presence of an inert gas to produce pyrolyzed carbon particles;
d. heating of the pyrolyzed carbon particles to 750 C to 1050 C in the presence of an activation gas to produce primary activated carbon particles, the primary activated carbon particles comprising a porous carbon framework; and
e. heating the primary activated carbon particles to 350 C to 450 C in the presence of a silicon-containing gas to impregnate silicon within the porous carbon framework,
wherein individual particles of the Group14 composite particles have a sphericity of greater than 0.5.

2. The process of claim 1, wherein the aqueous milieu comprises a co-solvent including one or more of: an alcohol, alkanes, ethers, THF, DMSO, DMF, N-methyl pyrrolidone, glycol, and glymp.

3. The process of claim 1, wherein the aqueous milieu is heated to a temperature less than or equal to a decomposition temperature of the preferential exclusion agent.

4. The process of claim 1, wherein the polyol is sucrose.

5. The process of claim 1, wherein the exclusion agent is: Span 80, poly(acrylic acid), Triton X, or a combination thereof.

6. The process of claim 1, wherein the ratio of polyol to the exclusion agent is 1000:1 or less.

7. The process of claim 1, wherein the inert gas is nitrogen.

8. The process of claim 1, wherein the activation gas is carbon dioxide, steam, or combinations thereof.

9. The process of claim 1, further comprising stirring the aqueous milieu.

10. The process of claim 1, wherein the silicon-containing gas deposits silicon onto at least a portion of a surface of the primary activated carbon particle.

11. The process of claim 1, wherein the fraction of silicon not impregnated within the porous carbon framework relative to the fraction of silicon impregnated within the porous carbon framework, Z, is less than 10.

12. The process of claim 11, wherein the impregnating silicon within the porous carbon framework comprises the deposit of a silicon nanoparticle within the interior framework of the activated carbon particles.

13. The process of claim 1, wherein the Group 14 composite particles further comprise two or more discrete Group 14 particles and wherein the discrete Group 14 particles are not agglomerated.

14. The process of claim 1, wherein a pore volume of the primary activated carbon is at least 0.6 cm3/g.

15. The process of claim 1, wherein the silicon-containing gas is introduced via chemical vapor infusion (CVI).

16. The process of claim 1, wherein the silicon-containing gas is silane.

17. The process of claim 1, further comprising casting a slurry comprising the Group 14 composite particles to produce an anode electrode.

18. A Group14 composite comprising:
(a) a plurality of porous carbon primary particles derived from a polyol, wherein the plurality of porous carbon particles exhibit a spherical morphology;
(b) silicon impregnated within pores of the porous carbon primary particles;
(c) Dv50 is less than or equal to 10 μm;
(d) Z<10; and
(e) phi (φ)≥0.15, wherein dQ/dV is measured in a half-cell coin cell, and regime I is 0.8V-0.4V and Regime III is 0.15V-0V.

19-25. (canceled)

26. A Group14 composite comprising:
(a) a plurality of primary particles comprising Group14 elements silicon and carbon, wherein the primary particles have a sphericity of at least 0.5, and wherein each particle comprises a porous carbon scaffold;
(b) 30% to 60% silicon by weight;
(c) Dv50 is less than or equal to 10 μm;
(d) Z<10; and
(e) phi (φ)≥0.15, wherein dQ/dV is measured in a half-cell coin cell, and regime I is 0.8V-0.4V and Regime III is 0.15V-0V.

27. A Group14 composite comprising carbon and silicon, wherein:
(a) the carbon comprises a porous carbon scaffold derived from a polyol and further comprising:
(i) amorphous carbon,
(ii) a pore volume, wherein greater than 70% of the pore volume is comprised of pores having a diameter less than 2 nm, and
(iii) a Dv90 less 50 nm;
(b) the silicon comprises:
(i) amorphous, nano-sized silicon embedded within the pore volume of the porous carbon scaffold; and
(c) the Group14 composite further comprises:
(i) 30% to 60% silicon by weight,
(ii) Dv50 is less than or equal to 10 μm,
(iii) Z<10, and
(iv) phi (φ)≥0.15, wherein dQ/dV is measured in a half-cell coin cell, and regime I is 0.8V-0.4V and Regime III is 0.15V-0V.

28-34. (canceled)

35. An energy storage device comprising the Group14 composite of claim 26.

36. The energy storage device of claim 35, wherein the energy storage device is a lithium-silicon battery or a lithium-ion battery.
